(19) United States
(12) Patent Application Publication
(10) Pub. No.: US 2007/0183339 A1
(43) Pub. Date: Aug. 9, 2007

(54) System and method of producing statistical information about call durations

(76) Inventors: Graham P. Rousell, Banbury (GB); Malcolm Myers, Kesgrave (GB); Michelle M. Waldorf, Plainfield, IL (US); Erin Baker, Singapore (SG)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/636,359

(22) Filed: Dec. 8, 2006

Related U.S. Application Data
(63) Continuation-in-part of application No. 11/302,316, filed on Dec. 12, 2005.
(60) Provisional application No. 60/654,287, filed on Feb. 18, 2005.
(60) Provisional application No. 60/748,571, filed on Dec. 8, 2005.

(51) Int. Cl. H04J 1/16

(52) U.S. Cl. 370/252; 370/465

(57) ABSTRACT

A method and system of evaluating network usage among signals experiencing varying enhancements or impairments collects data of network communications signals, which may describe parameters relating to the quality of the signal, such as noise level or echo level. Data, such as call durations data, is also collected describing the behavior of the callers using those signals. The system then correlates the signal data with the behavior data in order to determine how signal quality affects the duration or frequency of communications between callers. Ring tones, idle times, and other call parameters may be processed in a manner improving accuracy of the analysis. As a result, network usage may be evaluated in an objective manner that may also be directly relevant to network revenue. Data compression may be applied to store and analyze large volumes of call data.

### RELATED APPLICATIONS

This application is a continuation-in-part of U.S. patent application Ser. No. 11/302,316, filed on Dec. 12, 2005, which claims the benefit of U.S. Provisional Application No. 60/654,287, filed on Feb. 18, 2005, and this application also claims the benefit of U.S. Provisional Application No. 60/748,571 by Graham P. Rousell et al., filed on Dec. 8, 2005, entitled “Methods for Measuring Voice Quality.” The entire teachings of the above applications are incorporated herein by reference.

### BACKGROUND OF THE INVENTION

An existing method for measuring voice quality assigns mean opinion scores (MOS) related to speech heard on a communications circuit. Typically, in assigning a MOS, a numerical measure of quality of human speech, in the form of subjective tests or opinionated scores, is measured at the destination end of a communications circuit. For example, a subjective test can involve asking a group of listeners to rate quality of test sentences read aloud over the communications circuit by male and female speakers. Each listener then gives each sentence a rating, such as: 1 (bad); 2 (poor); 3 (fair); 4 (good); 5 (excellent). An arithmetic mean of all of the individual scores is then calculated.

Another existing method for measuring voice quality uses an ITU-T perceptual analysis algorithm such as P.862, which calculates MOS without using human participants, and is typically performed in a laboratory environment. Tests may also be performed by operators by “drive testing.”

### SUMMARY OF THE INVENTION

An embodiment of the present invention includes a system, or corresponding method, of evaluating network usage. The system collects data of network communications signals, which may describe parameters relating to quality of the network communications signals, such as noise level or echo level. Data describing the behavior of the callers using those signals, such as call duration, is also collected. The system then correlates the signal data with the behavior data in order to determine how signal quality affects the duration or frequency of communications. As a result, embodiments of the present invention may evaluate network usage in an objective manner.

The technique described above for evaluating network usage may be applied to a service provider's network to measure behavior data of a test group and a control group on the service provider's network. In this way, a signal enhancement system may be marketed to the service provider in part by informing the service provider of a difference between the behavior data of the test group and the behavior data of the control group due to the signal enhancement system as applied to the service provider's network.

Another embodiment of the present invention includes a system or corresponding method of producing information about call duration. A subset of communication signals are modified. The signals may, for example, be impaired or enhanced. The modified and non-modified signals are then captured. The system then analyzes the captured results to determine each individual call's duration. Information describing the call duration may then be created.

### BRIEF DESCRIPTION OF THE DRAWINGS

The foregoing and other objects, features and advantages of the invention will be apparent from the following more particular description of example embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is an illustration of an exemplary embodiment of the present invention.

FIG. 1B is a flow diagram depicting a process of the embodiment of FIG. 1A.

FIG. 2-4 are block diagrams illustrating exemplary embodiments of the present invention.

FIGS. 5-9 are data charts illustrating results of an exemplary embodiment of the present invention.

FIG. 10 is a diagram illustrating how an exemplary embodiment of the present invention may be used to market voice quality enhancement systems.

FIG. 11 is a flow diagram of an example process for collecting and analyzing the call data.

FIG. 12A is another exemplary embodiment of the present invention.

FIG. 12B is another embodiment in which the data capture unit and data analyzer are integrated into a single unit.

FIG. 13 is a flow diagram depicting an example process of the embodiments of FIGS. 12A and 12B.

FIG. 14 is a block diagram of the signal modifier unit.

FIG. 15 is a flow diagram depicting an example process of the signal modifier unit illustrated in FIG. 14.

FIGS. 16-18 are screen shots illustrating exemplary graphical user interfaces (GUIs) for use with embodiments of a data capture unit.

FIG. 19 is a screen shot illustrating an exemplary GUI for use with an embodiment of a data analyzer.

FIG. 20 is a block diagram illustrating an exemplary embodiment of a data analyzer.

FIG. 21 is a flow diagram depicting an example process of the embodiment of FIG. 20.

FIG. 22 is a screen shot illustrating an exemplary GUI embodiment of a configuration file for use with a data analyzer.

FIG. 23 is a block diagram of memory buffers used by the data analyzer of FIG. 20 that may be employed in an embodiment of the present invention.

FIGS. 24A-D are diagrams of a Voice Quality Enhancement (VQE) Peak (VPK) logic used by the data analyzer of FIG. 20 to compress captured data optionally employed in an embodiment of the present invention.

### DETAILED DESCRIPTION OF THE INVENTION

A description of example embodiments of the invention follows.

An embodiment of the present invention measures the effect voice quality has on consumer behavior. Unlike measuring voice quality by taking mean opinion scores (MOS), embodiments of the present invention avoid qualitative measurement of voice quality. Unlike measuring voice quality using an ITU-T perceptual analysis algorithm such as P.862, embodiments of the present invention can take actual quantitative measurements of consumer behavior for calls made in a communications network.

Embodiments of the present invention can measure voice quality by measuring parameters in an actual consumer use environment and can use experimental research and statistical analysis to non-intrusively measure the voice quality. As a result, some embodiments of the present invention can take into consideration factors affecting voice quality, including voice quality impairments (such as echo) or voice quality improvements (such as echo cancellation).

In an exemplary embodiment of the present invention, call duration (CD), the duration between the start and end of a call, is measured. One reason to correlate voice quality to call duration is that, if a caller (i.e., customer or consumer) is not satisfied with the voice quality of the current call, the caller will likely quickly end the call. Furthermore, if the caller is using a mobile phone, the caller will likely end the call and redial on a wireline phone.

Another reason for correlating voice quality to call duration is that factors, such as speech level, low signal-to-noise ratio, acoustic echo, hybrid echo, coding distortion, and circuit delay, can have an impact on call duration. Therefore, an embodiment of the present invention can be helpful to determine an impact on voice quality due to a change in a communications network, such as an addition of an echo canceller or voice quality enhancement product or feature (EC/VQE) to a communications network. Examples of EC/VQE include a mobile telephone adapter, telephone adapter, hybrid echo control, acoustic echo control, noise suppression, noise reduction, or level control.

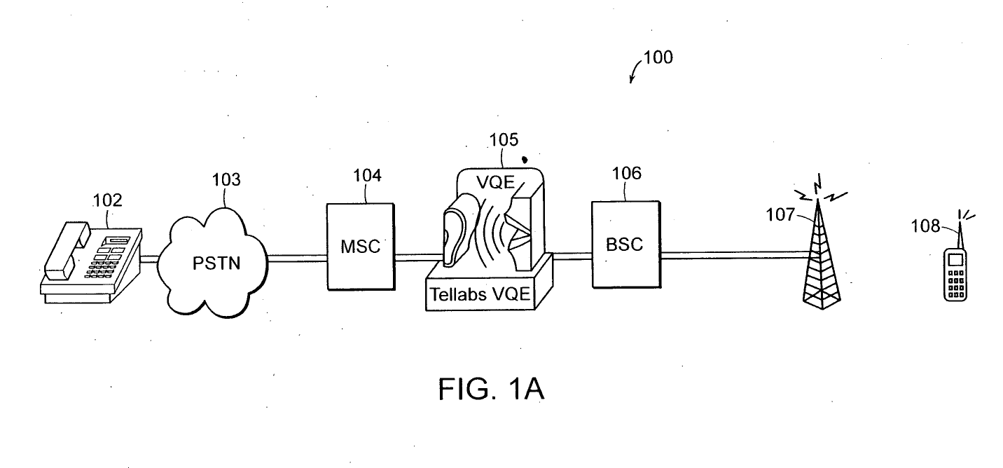

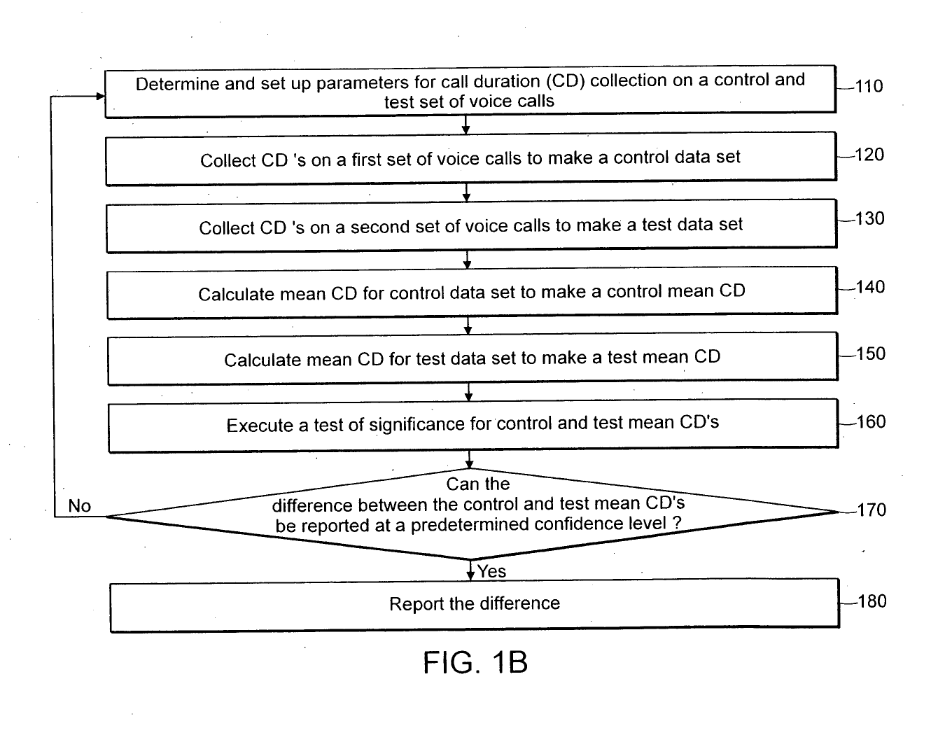

FIG. 1A illustrates a typical communications system 100 to which an embodiment of the present invention may be applied. Two users, one operating a telephone 102 and the other operating a mobile phone 108, communicate with one another through a network of several network elements. The telephone 102 connects by stationary wire to a public switched telephone network (PSTN) 103, which sends communications signals to a mobile switching center (MSC) 104. Between the MSC and a base station controller (BSC) 106, the signals pass through a voice quality enhancement (VQE) system 105, which applies one or more signal enhancements, such as noise reduction or acoustic echo cancellation, to the signal to enhance sound quality for the end user operating the mobile phone 108. The enhanced signals then pass to an antenna tower 107, which transmits the signal to the mobile phone 108. Likewise, the user operating the mobile phone 108 may transmit signals through the same network, resulting in signals enhanced by the VQE system 105 for enhanced voice quality at the telephone 102.

Enhanced voice or sound quality may increase an amount of time that callers use a phone service, thereby increasing revenue for the phone service provider. While the system 100 improves sound quality through use of the VQE 105, the system 100 alone cannot determine whether this improvement actually results in increased call duration or increased revenue over systems without VQE. There is also the effect that increasing quality could decrease call holding time (message is sent clearer and quicker), just as decreasing quality can increase call hold time (some echo makes for repetition of the message). Analysis by this method shows the effect of impairment or improvement levels on call hold time. Embodiments of the present invention provide a way to determine how differences in signal quality affect caller behavior, allowing service providers to see the results of enhancement systems in terms of caller data that directly affect revenue.

It should be understood that the communications system 100 may be a 2G mobile network, 3G mobile network, include voice-over-Internet Protocol (VoIP), or include any combination of present or future communication systems, subsystems, protocols, and so forth.

FIG. 1B illustrates, in the form of a flow diagram, an exemplary embodiment of the present invention. It should, however, be evident that various modifications and changes may be made thereto without departing from the broader spirit and scope of the present invention. For example, some of the illustrated flow diagrams may be performed in an order other than that which is described. It should be appreciated that not all of the illustrated flow diagrams is required to be performed, that additional flow diagram(s) may be added, and that some may be substituted with other flow diagram(s).

The embodiment of FIG. 1B collects call durations for a sampling of voice calls to make a control data set and collects call durations for a sampling of voice calls to make a test data set. In the control data set, call durations are collected on channels where there is no EC/VQE, and in the test data set, call durations are collected on channels where there is EC/VQE.

Parameters for call duration collection on a control and test set of voice calls are determined and set-up (element 110). Depending upon what voice quality conclusions or effects of EC/VQE are to be reported, parameters can be selected from one or more of the following or similar parameters: voice call impairment(s), EC/VQE application(s), time, location of the voice calls, network element transmitting or receiving the voice calls, and number of voice calls.

The control and test sets of voice calls are preferably gathered at the same time and location to eliminate effects of time and location on call duration. In this way, effects of EC/VQE equipment, or other equipment is accurately assessed.

Regarding the parameter of voice call impairment(s), call durations can be collected on voice calls having one or more impairments, such as calls with objectionable acoustic echo, calls with low level uplink, calls with low level downlink, calls with high level uplink, calls with high levels downlink, and calls with high background noise.

Regarding the parameter of EC/VQE application(s), call durations can be collected on a control set of voice calls where a particular EC/VQE application is not used (element 120), and call durations can be collected on a test set of voice calls where one or more particular EC/VQE applications are used (e.g., mobile telephone adapter, telephone adapter, hybrid echo control, acoustic echo control, noise suppression, noise reduction, or level control) (element 130).

Regarding the parameter of time, the time can be at a certain time (e.g., morning, afternoon, evening, particular time during a business day) or on a certain day (e.g., business day, holiday, weekend day, or particular day of the week) or days (e.g., a one week period, a one month period).

Regarding the parameters of location of the voice call and network elements transmitting or receiving the voice calls, location can be, for example, a particular site (e.g., a business location or particular place within a city) or a particular area (e.g., residential area, business area, town, metropolitan area, or part of a metropolitan area). In one embodiment of the present invention, it is important, that the two sample sets of calls are taken from similar environments and substantially simultaneously, to reduce variability between the two sets, if not within them.

Location of call duration collection can be anywhere on a network, such as where voice calls are transmitted or where EC/VQE may be employed. For example, call durations can be collected on channels on transmission links, such as types T1, E1, T3, E3, OC-3, and STM-1. Furthermore, call durations can be collected on transmission links between network elements or within a network element, and the communications network may be a wireline or wireless network.

After collection of call durations on the control and test set of voice calls is made, a mean (i.e., average) call duration for the control data set is calculated to determine a control mean call duration (element 140). Similarly, a mean call duration for the test data set is calculated to determine a test mean call duration (element 150). A test of significance is then executed for the control and test mean call durations (element 160). If a difference between the control and test mean call durations can be reported at a predetermined confidence level, such as 95% confidence (element 170), the difference is reported (element 180). Otherwise, additional collection and calculations are performed (elements 110-160) until the difference between the control and test mean call durations can be reported at the predetermined confidence level (element 170). It should be understood that if the difference does not achieve a predetermined confidence level within a given timeframe, collection of the call durations may be reconsidered and moved from the location(s) the collection is performed to different location(s).

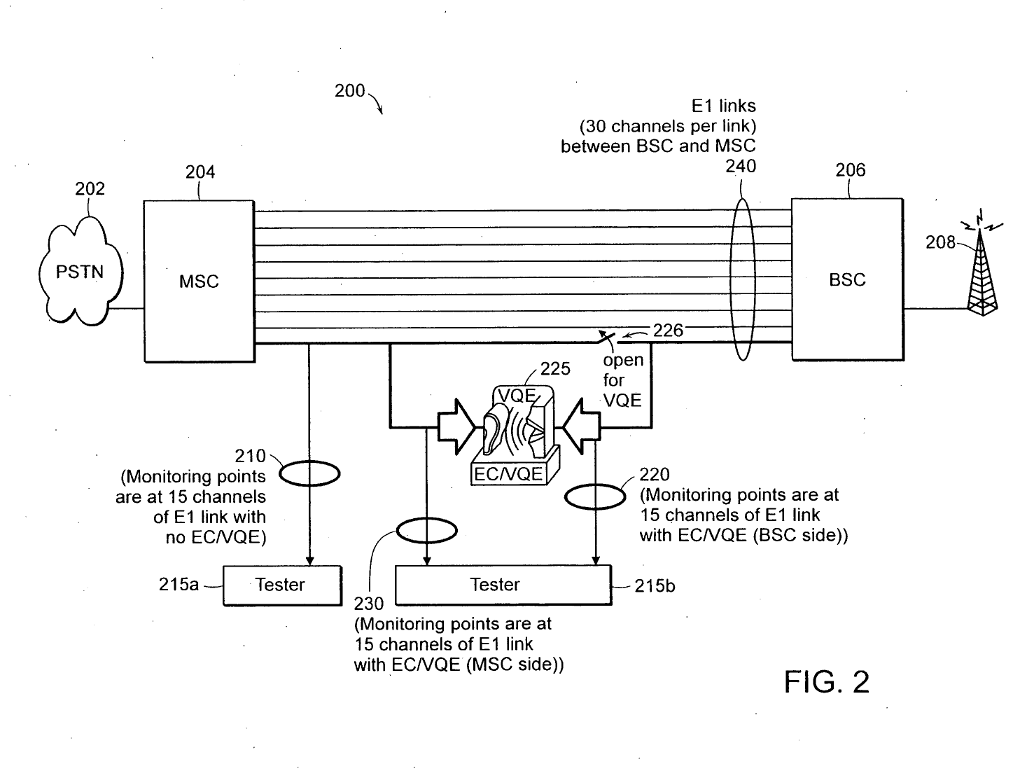

Elements 120-180 are briefly described again below following discussion of FIGS. 2-4, which provide physical context for the flow diagram of FIG. 1.

FIGS. 2-4 illustrate exemplary embodiments of the present invention, where various parameters are selected that relate to location of the voice call and network elements transmitting or receiving the voice calls.

FIG. 2 illustrates placement of data collection device(s) (“tester(s)”) 215a, 215b in a network 200 where call durations can be collected by at least one tester 215a, 215b, according to an exemplary embodiment. The tester(s) 215a, 215b may be a single unit, two units, or more than two units. As understood in the art of multiple units, the tester(s) 215a, 215b are calibrated or use certain signals on the links 240 that can be used to ensure data collected on one tester 215a is captured at essentially the same level(s) as on another tester 215b. The tester(s) 215a, 215b may be physically moved to collect data from different locations on the network 200, or the tester(s) 215a, 215b may be connected to the network 200 at a fixed location and have network connections switched or otherwise configured to allow the tester(s) 215a, 215b to receive communications to make the measurements.

FIG. 2 further shows multiple transmission links (e.g., E1 transmission links) between a first network element (e.g., a mobile switching center (MSC)) 204, which is connected to a public switched telephone network 202, and a second network element (e.g., a base station controller (BSC)) 206, which is connected to an antenna tower 208. An MSC provides services between mobile users in a network and external networks. A BSC manages radio resources in global system for mobile communications (GSM) for specified cells within a public land mobile network (PLMN).

Each transmission link 240 carries a particular number of channels. For example, an E1 transmission link carries up to thirty voice channels. For the control data set, call durations can be collected via test link 210 connected to a number of channels that do not have EC/VQE 225 and that are on a particular transmission link. For example, for the control data set, call durations can be collected on fifteen of the thirty channels of a particular E1 transmission link. For the test data set, call durations are collected via test links 220 and 230 connected to a number of channels that have EC/VQE 225, with a switch 226 or the like to enable introduction of signal(s) processed by the EC/VQE 225 onto respective channels, and that are on the same transmission link. For example, for the test data set, call durations can be collected on the other fifteen of the thirty channels on the same E1 transmission link on which the control data set is collected. In this embodiment, since the mean of the data samples are used instead of sums, there is no need to adjust the sample sets due to the difference in number of channels used in each sample.

Within a transmission link, channels can be designated for the control data set or the test data set in various ways. In one way, of all the channels on a particular transmission link, one half of the channels can be designated for the control data set, the other half of the channels can be designated for the test data set, and the channel designations can be interleaved or alternated. For example, for an exemplary embodiment of thirty channels on an E1 transmission link, the even numbered channels can be designated for the control data set, and the odd numbered channels can be designated for the test data set. Another way of designating channels on a transmission link is that the channels on a particular transmission link can be randomly designated for each of the control and test data sets. Yet another way of designating channels is that the first half of the channels on a transmission link (e.g., channels numbered 1-15 of the thirty channels on an E1 transmission link) can be designated for the control data set and the second half of the channels (e.g., channels numbered 16-30 of the 30 channels on the same E1 transmission link) can be designated for the test data set.

In some E1 links, E1 timeslot numbers are 1-15, 16-31, that is 31 timeslots. When timeslot 16 is a signaling timeslot there are 30 channels (15 on and 15 off). In such a situation the control channels or test channels may be fourteen and fifteen channels, respectively. Since averaging is used, the difference has negligible effect.

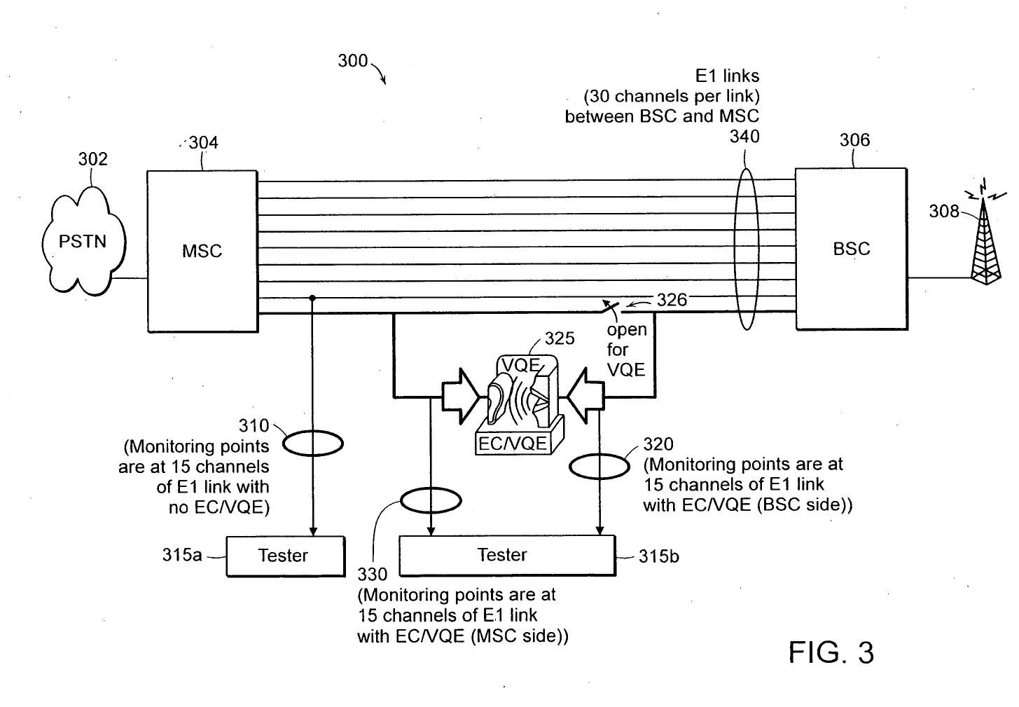

FIG. 3 illustrates placement in a network 300 where call durations can be collected, according to another exemplary embodiment. FIG. 3 shows multiple transmission links (e.g., E1 transmission links 340) between a first network element (e.g., an MSC 304 connected to a subnetwork (e.g., PSTN) 302) and a second network element (e.g., a BSC). In this exemplary embodiment, for the control data set, call durations are collected at point 310 on a number channels that do not have EC/VQE and that are on a particular transmission link. For example, for the control data set, call durations can be collected on fifteen of the thirty channels of a particular E1 transmission link. For the test data set, call durations are collected via test links 320 and 330 connected to a number of channels that have EC/VQE 325 operating on them, via a switch 326 or other technique for applying signals from the EC/VQE onto the channels, and that are on a different transmission link. For example, for the test data set, call durations can be collected on the fifteen of the thirty channels on a different E1 transmission link. Therefore, FIG. 3 illustrates that call durations can be collected on one or more transmission links between two network elements.

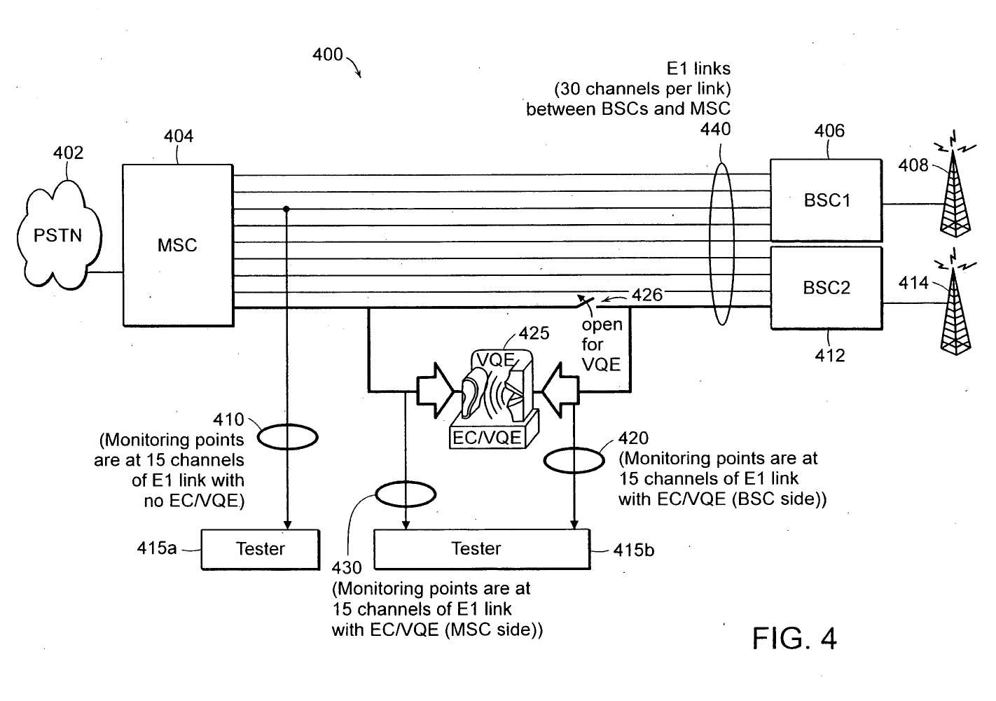

FIG. 4 illustrates placement in a network 400 where call durations can be collected, according to yet another exemplary embodiment. FIG. 4 shows multiple transmission links (e.g., E1 transmission links) 440 between multiple network elements (e.g., an MSC 404 and two BSCs 406, 412) connected to a subnetwork (e.g., PSTN) 402 and antenna towers 408, 414, respectively. In this exemplary embodiment, for the control data set, call durations are collected via test link 410 connected to a number channels that do not have EC/VQE and that are on a particular transmission link connected to a particular BSC 406, 412. For example, for the control data set, call durations can be collected on fifteen of the thirty channels of a particular E1 transmission link, which is connected to BSC1 406. For the test data set, call durations are collected via test links 420 and 430 connected to a number of channels that have EC/VQE 425 and a corresponding switch 426 and that are on a different transmission link connected to a different BSC. For example, for the test data set, call durations can be collected on the fifteen of the thirty channels on a different E1 transmission link, which is connected to BSC2 412. Therefore, FIG. 4 illustrates that call durations can be collected on one or more transmission links connected to different and multiple network elements. However, samples taken from separate BSC's are undesirable unless they are known to be covering the same geographical area.

With a physical understanding of data collection configurations, reference is made again to FIG. 1B. At element 120, call durations are collected on one or more communications circuits to make a control data set. For example, call durations for 100,000 calls are collected on fifteen voice channels, each channel having no EC/VQE.

At element 130, call durations are collected on the one or more communication circuits to make a test data set. For example, call durations for 100,000 calls are collected on fifteen voice channels, each channel having EC/VQE.

At element 140, a mean (i.e., average) call duration is calculated for the control data set. A mean call duration can be calculated using existing mean calculation methods. For example, mean can be calculated as: mean call duration x′=Σx*f(x), where x is call duration and f(x)=instances of x test call durations/actual sample size n.

At element 150, the mean call duration is calculated for the test data set.

At element 160, a test of significance is executed for the control and test mean call durations. The test of significance used can be an existing test of significance method. For example, a test of significance that can be used is as follows:

$$z = \frac{( {\overline{x}}_{1} - {\overline{x}}_{2} ) - ( {μ}_{1} - {μ}_{2} )}{\sqrt{\frac{{σ}_{1}^{2}}{{n}_{1}} + \frac{{σ}_{2}^{2}}{{n}_{2}}}} \qquad ( Equation 1 )$$

where z is a one-tailed two-sample z statistic (e.g., value of 1.645 when a confidence level of 95% is desired), x₁ and x₂ are the control and test mean call durations (i.e., samples representing characteristics of the entire population of voice calls), μ₁ and μ₂ are unknown means of the entire population of voice calls, σ₁ and σ₂ are the standard deviations of the control and test mean call durations, and n₁ and n₂ are the number of voice calls (actual sample sizes). The standard deviation can be calculated as: standard deviation σ=sqrt((x′−x)²*f(x)), where x is call duration, f(x)=instances of x test call durations/actual sample size n. This test of significance begins with a null hypothesis Ho: μ₁−μ₂=0 and, accordingly, (μ₁−μ₂) is set to zero. In an alternative embodiment, z may be a two-tailed two sample z statistic (e.g., value of 1.96 when a confidence level of 95% is desired). U.S. Provisional Application No. 60/654,287, the entire teachings of which are incorporated herein by reference, includes additional information regarding tests of significance.

Continuing to refer to FIG. 1B, at element 170, results of the test of significance are compared against a predetermined confidence level to determine a difference between the control and test mean call durations and can be reported at the predetermined confidence level. For example, after inputting x₁, X₂, (μ₁−μ₂), σ₁, σ₂, n₁ and n₂ into Equation 1, the outcome can be z=1.6. The outcome 1.6 can be compared against a value of z for a predetermined confidence level (e.g., a value of z should be 1.645 when a confidence level of 95% is desired). If the difference cannot be reported at the predetermined confidence level, the next element is element 10, where the parameters for call duration collection are adjusted or re-determined and set-up. For example, the number of voice calls for call duration collection can be increased to take a larger sampling of voice calls (n₁ and n₂). If in element 170 the difference between the control and test mean call durations can be reported at a predetermined confidence level, the next element is element 180, where the difference between the control and test mean call duration is reported. The difference between the control and test mean call duration against a confidence level may be reported graphically, as a metric, in tabular form, electronically, or in any other manner understood in the art.

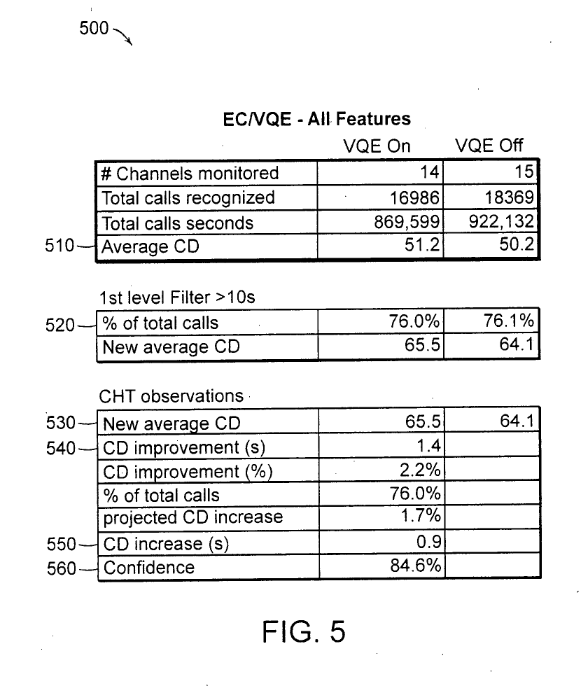

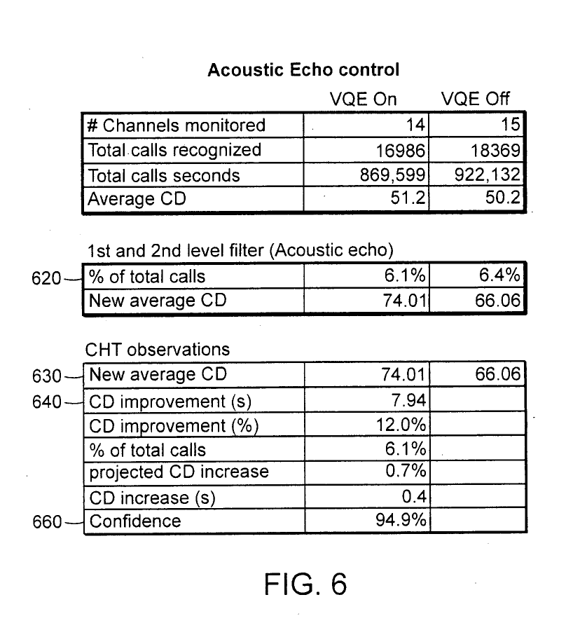

FIGS. 5-9 illustrate reporting of exemplary results, according to various exemplary embodiments of the present invention, having various parameters for call duration collection. The charts compare two sets of calls; in each figure, the left column provides data of calls passed through a VQE system, and the right column provides data of calls with no voice enhancement through the VQE system. FIGS. 5-9 utilize the same data set of approximately 35,000 calls, as shown in the uppermost box, and analyze the effects of individual voice enhancers on call duration. FIGS. 5-9 are described immediately below, in turn.

FIG. 5 is a chart 500 depicting exemplary results when multiple EC/VQE functions are applied to a network. Among all sampled calls, the average call duration 510 of calls with VQE is shown to be 0.9 s higher than calls without VQE. In this example, a first-level filter eliminates all calls under 10 s because such calls are probably not long enough for voice quality to affect call duration. Such shorter calls may include calls that are not answered, calls with short or incomplete handovers, or calls where a voicemail is reached and no message is left. Upon filtering-out such shorter calls to a percentage of total calls 520, a new average call duration 530 is shown. This new average call duration 530 of calls with VQE is notably higher than the average call duration 530 of calls without VQE, resulting in a call duration improvement 540 of 1.4 s. From this data, a call duration increase 550 over all calls can be projected at 0.9 s. As a result, a confidence interval 560 of 84.6% is attained, meaning that the data shows approximately 85% confidence that a positive improvement in call duration is achieved with multiple EC/VQE.

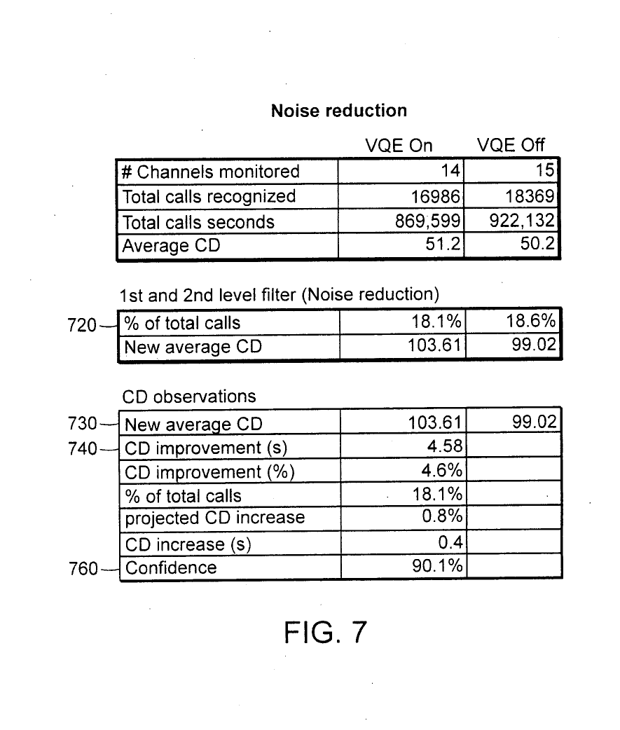

FIG. 6 illustrates exemplary results when a single EC/VQE, acoustic echo control, is applied to a network. Using the same data set as in FIG. 5, a second filter is applied to arrive at a percentage of total calls 620 with acoustic echo control, and a new average call duration 630 is shown. This new average call duration 630 of calls with echo control is notably higher than the new, average, call duration 630 of calls without echo control, resulting in a call duration improvement 640 of 7.94 s. As a result, a confidence interval 660 of approximately 95% (e.g., ±5%, ±1%, ±0.5%) shows that a positive improvement in call duration is almost certainly attained by using acoustic echo control.

FIG. 7 illustrates exemplary results when a single EC/VQE feature, noise reduction, is applied to a network. Using the same data set as in FIG. 5, a second filter is applied to arrive at a percentage of total calls 720 with noise reduction, and a new average call duration 730 is shown. This new average call duration 730 of calls with noise reduction is notably higher than the new average call duration 730 of calls without noise reduction, resulting in a call duration improvement 740 of 4.58 s. As a result, a confidence interval 760 of 90.1% shows that a positive improvement in call duration is almost certainly attained by using noise reduction.

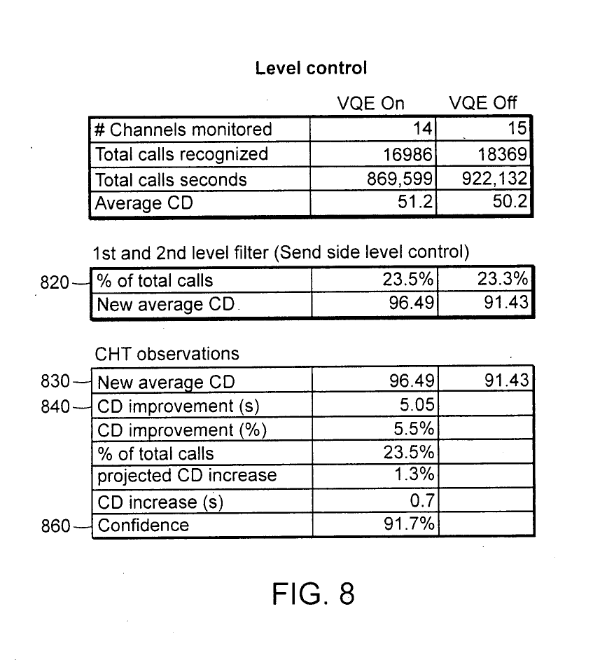

FIG. 8 illustrates exemplary results when a single EC/VQE, level control, is applied to a network. Using the same data set as in FIG. 5, a second filter is applied to arrive at a percentage of total calls 820 with noise reduction, and a new average call duration 830 is shown. This new average call duration 830 of calls with noise reduction is notably higher than the new average call duration 830 of calls without noise reduction, resulting in a call duration improvement 840 of 5.05 s. As a result, a confidence interval 860 of 91.7% shows that a positive improvement in call duration is almost certainly attained by using level control.

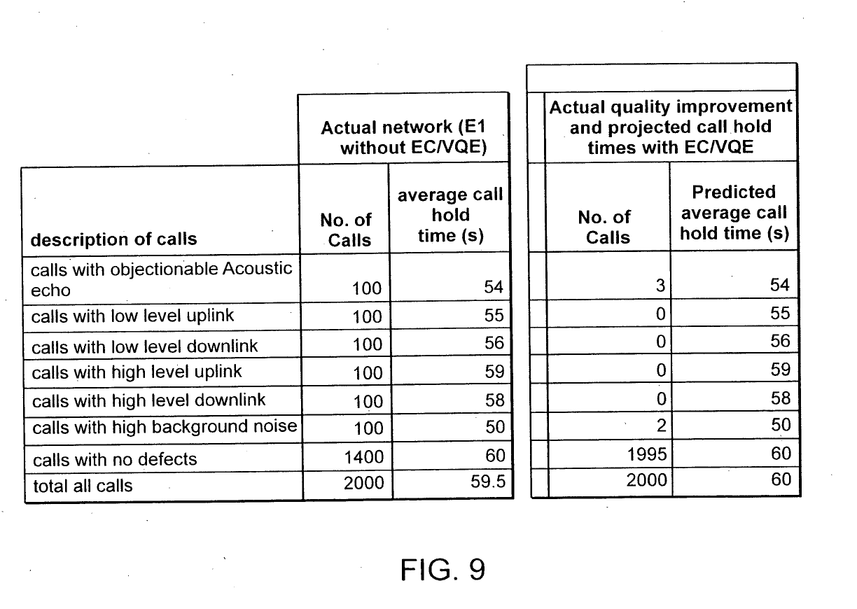

FIG. 9 illustrates exemplary results after (i) breaking-down the control and test data sets into subsets of calls having a particular impairment, such as calls with objectionable acoustic echo, calls with low level uplink, calls with low level downlink, calls with high levels uplink, calls with high levels downlink, calls with high background noise, and (ii) applying an exemplary embodiment of the present invention.

In the foregoing description, the present invention is described with reference to specific example embodiments thereof. It should, however, be evident that various modifications and changes may be made thereto without departing from the broader spirit and scope of the present invention. For example, embodiments of the present invention may be provided as a computer program product, or software, that may include a machine-readable medium having stored thereon instructions. Further, a machine-readable medium may be used to program a computer system or other electronic device, and the readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. The specification and drawings are accordingly to be regarded in an illustrative rather than in a restrictive sense.

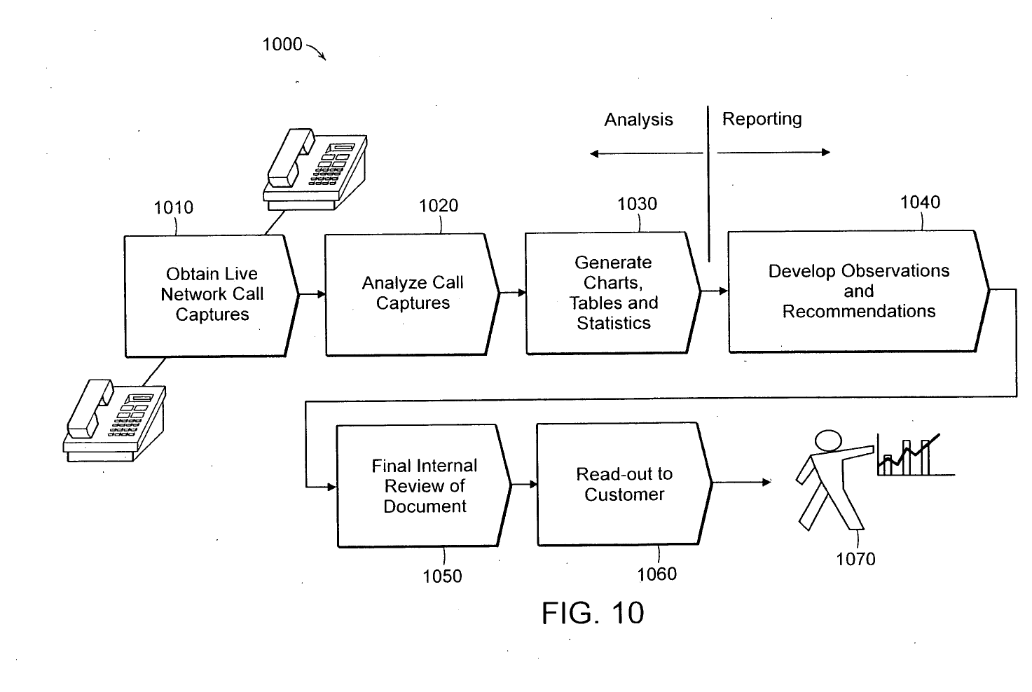

FIG. 10 illustrates a method 1000 for marketing a VQE system to a potential customer, such as a communications service provider, using an embodiment of the present invention. Several calls are captured from a potential customer's network (element 1010), where capturing calls may include recording behavior data, such as call duration, among calls with and without the VQE system. The call data may be analyzed (element 1020) to determine the differences in caller behavior between enhanced and non-enhanced calls. Various charts and other statistics may be generated (element 1030) to illustrate this difference in caller behavior. From these statistics, observations can be drawn (element 1040) about effect(s) of the VQE on the potential customer's network, as well as how to recommend the VQE to the potential customer. These findings may undergo a final internal review (element 1050), and may then presented to the potential customer (elements 1060, 1070).

As a result of this method 1000, marketers of VQE systems may provide service providers with substantial and useful data on the effect of a VQE system on their network. So, for service providers who charge customers on a per minute basis, the marketer of the VQE system can illustrate to a given level of confidence that callers, who keep their calls below a “next calling minute” (e.g., 58 seconds, 1 minute 58 seconds, etc.) without VQE in the network, will likely cross into the next calling minute (e.g., 1 minute 2 second, 2 minutes 2 seconds) if the network is equipped with the VQE systems. Moreover, by applying the VQE system to the service provider's own network and capturing the data as described above, the marketer can sit across a conference table from a service provider executive, for example, and present actual results to the service provider representative to market the VQE system in a convincing manner.

Referring now to details of hardware and software aspects of the tester 215a, 215b, the operation of the tester 215a, 215b is such that the capture process operates unattended and that the analysis process is able to identify and analyze individual call samples within the bulk captures without a requirement of analyzing a signaling channel for call start and stop times.

Analyzing signaling information is the most reliable way of identifying individual call samples; however, this requires a particular protocol to be loaded onto the analyzer, of which there are considerable variants. It is also likely that the signaling channel of interest is in a completely different channel bearer (e.g., wireline or optical fiber) to that being analyzed, and so the mapping of the channel bearers must be known within the signaling channel.

Some embodiments use an approach to analyzing individual calls with a high degree of accuracy by filtering conditions observed within the traffic channels. Embodiments may also analyze what is considered to be the “billable” portion of the call, optionally identifying and removing from the analysis any initial ring tone present before the called party answers.

The end result is determined by comparing two data sets for trend differences, so any errors resulting from mis-identification of calls are equally applied on both sample sets and, therefore, can be ignored.

It should be noted that this process does not require call samples to be “listened to” by the human operator, thereby protecting caller privacy of content passed through the networks.

Given that the network to be analyzed operates with, but need not be limited to, ITU-T G.711 coded signals contained within traffic channels on a multiple channel bearer, typically including but not limited to a G.703/704 E1 or T1 format, the capture engine makes programmed captures of the complete channel bearer. The ability to make captures may be dependent on the use of suitable interface modules between a personal computer (PC) (e.g., tester 215a, 215b) and the telecommunications network, as well as the capability of the PC operating system and disc storage capacity to store individual files of multiple gigabyte size continuously or in multiple captures of shorter duration to the maximum capacity. A capture engine, once programmed, can perform this task unattended.

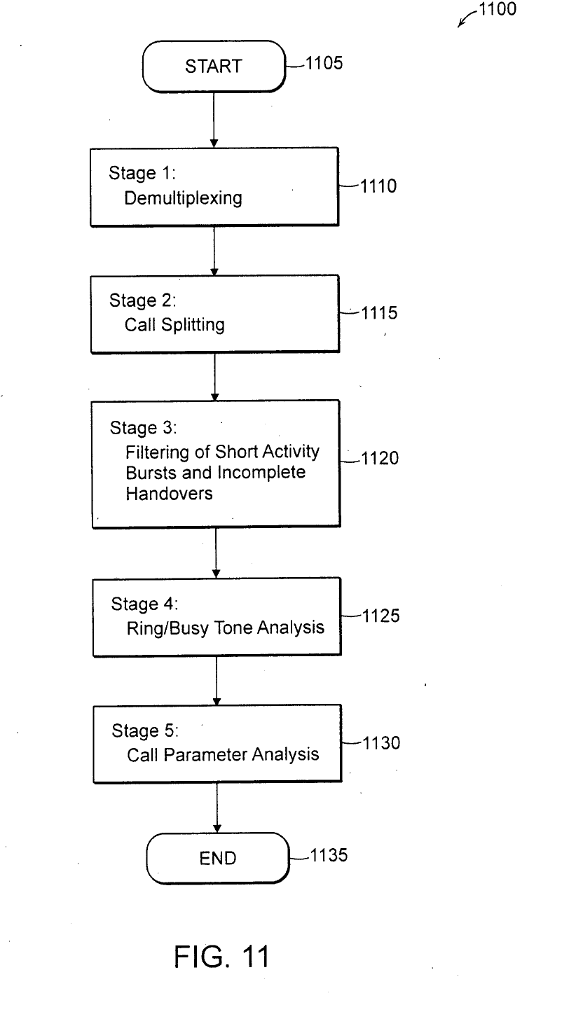

FIG. 11 is a flow diagram of an analysis process 1100, using one embodiment of the present invention, that may use five stages of filtering and analysis to arrive at details pertaining to characteristics of calls within the network. A description below of the analysis process is for one embodiment. It should be understood that other embodiments may also be performed using the same number of stages, more or fewer stages, or other techniques producing the results described above.

Stage 1—Demultiplexing

After the analysis process 1100 starts, a first stage of the analysis process 1100 may extract individual channels from the multiple channel bearer. It is a straightforward division that follows the ITU-T G.703/704 guidelines for frame structure but may equally be applied to any multiple channel bearer. The individual channels (containing multiple call samples) may then be stored into new folders on the PC for further analysis.

Stage 2—Call Splitting 1115

The second stage of the analysis parses each channel capture to identify a start and stop of each call. Identification is primarily conducted with the knowledge that when there is no call activity within a channel, there is a defined “idle code” present in both directions of the channel. A number of idle codes are present in different networks, and the technique of the second stage extracts and stores individual files when one or both sides changes from the defined code for the duration of the change. These changes can be considered calls; however, there are many occasions within general network traffic, especially within mobile networks, when only one side of the circuit may have call activity (due to network handover or call set-up processes) or when callers may try to establish a call but the called party is not present, and, consequently, the call is never established (only ring tone is present). For this reason, further stages of filtering may be applied in the analysis process 1100 to filter-out invalid call conditions.

Stage 3—Filtering of Short Activity Bursts and Incomplete Handovers 1120

As a mobile handset user moves from cell to cell, the network tracks and allocates resources in other cells to allow the user to continue the conversation. This movement of tracking and allocating of resources are referred to as “handovers.” Often, the network prepares to provide resources of an available voice channel, only to realize this is not required as the user moves into a different area or the radio quality improves where the user is located. This effect manifests itself as call activity seen on one direction of the transmission path, but no activity in the other direction. The call in the meantime may continue quite satisfactorily within another voice channel and, therefore, is preferably not considered as a call passing over the channel being analyzed.

These samples may, therefore, be analyzed for unidirectional activity for the duration of the stored sample and removed from analysis if there is no activity throughout.

Another consideration is where the handover may take some length of time to complete and, at the end of it, there is only a small amount of bidirectional activity, which is preferably considered of no value in the overall analysis. The technique of stage 3 1120 may provide a means to optimize a minimum amount of bidirectional activity accepted for final analysis as a percentage of the overall file length or in terms of duration in seconds.

Stage 4—Ring/Busy Tone Analysis 1125

A considerable proportion of calls within networks are not established where the user may not be available (continuous ring tone) or are busy on another call (continuous busy tone). These situations are not typically billable and, therefore, may result in skewed data within a call holding time analysis. As an example, a call sample may show that a caller waited for thirty seconds for a call to be answered, and then the caller only spoke for fifteen seconds. The billable time was fifteen seconds; however, the total sample time is seen to be forty-five seconds. This may have a big effect on observed network call duration if it is not taken into account.

Another situation occurs when a call is answered (and billing starts), but then the call is transferred, where a second or further ring tones may be present. It is preferable that these calls, including the transfer, are not removed from any analysis as they are part of the billable time.

The analysis in stage 4 1125 may include a capability to recognize network progress once at the start of a call sample prior to speech activity and can therefore remove the portion with ring-tone from the analysis. This benefits the analysis also because, if the purpose of the analysis is to measure speech level characteristics, they are not being affected by the presence of a ring tone.

By not removing but separately reporting the presence and duration of a ring tone, it is possible to identify if the mobile user originated or received a call. Given that the original captures are made on the mobile network's A-Interface (i.e., a standard interface between the MSC and Transcoder), there is no ring tone present in the mobile set to MSC direction. This is so because the ring tone is generated toward a far end caller by the MSC, yet calls originated by the mobile user have network tones present (as heard by the mobile user). Therefore, it is possible to separate, with a high degree of confidence, mobile originated and mobile received calls within the final analysis.

Stage 5—Call Parameter Analysis 1130

This stage takes each of the call samples resulting from the previous stage's filtering and analyzes them for characteristics affecting call quality, namely: echo—from both the mobile set (acoustic echo) and the network (hybrid or electrical echo), speech levels, noise levels, call duration, and ring/busy tone duration. The resulting output from this can be a spreadsheet or database of data, which can be used for analysis of call characteristics and trends.

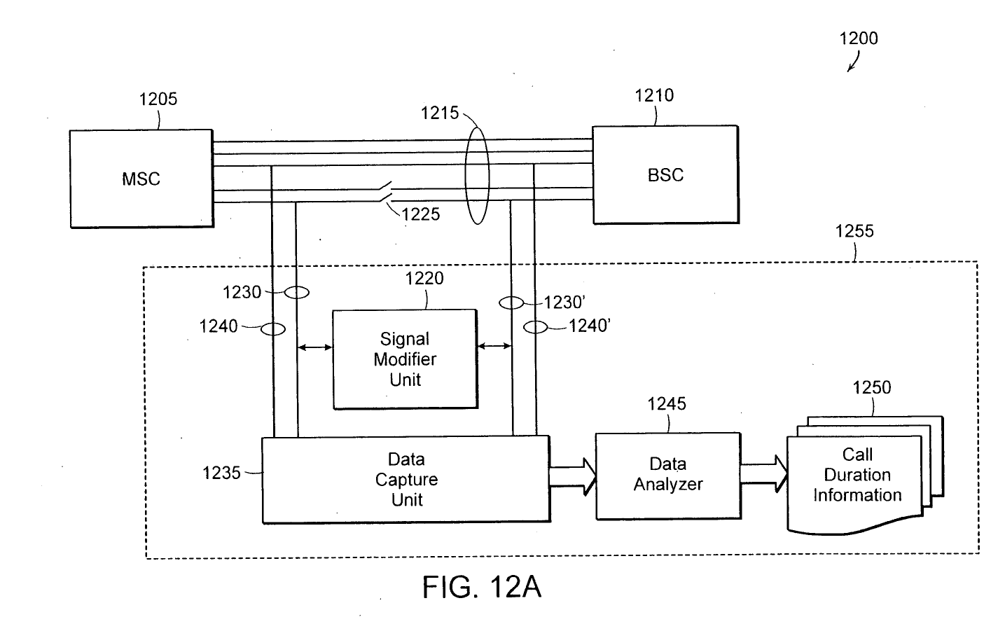

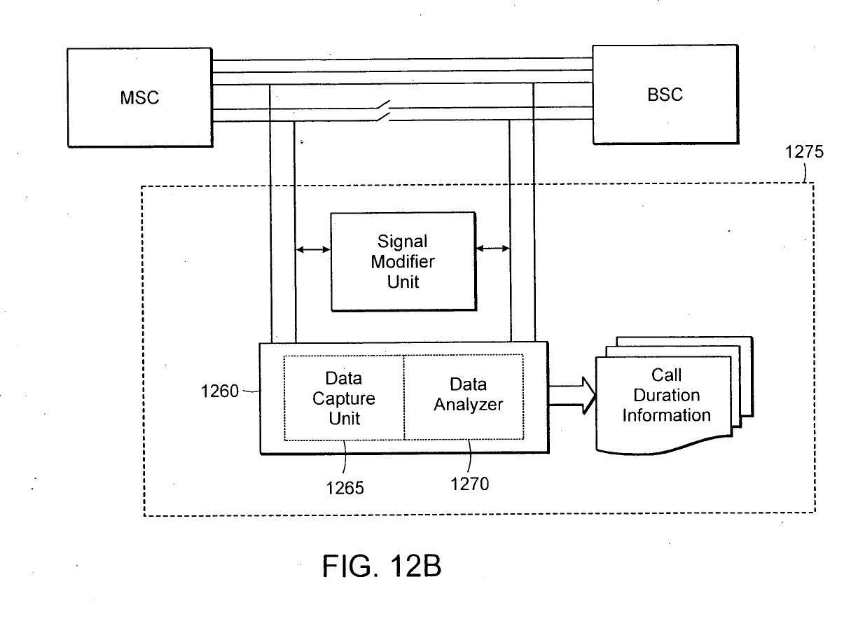

FIGS. 12A-24D illustrate exemplary embodiments of the present invention detailing example systems, apparatuses, and methods to determine duration of a call and producing statistical information about the call's duration.

In one example embodiment, statistical information about call durations is produced by modifying a subset of communications signals on a network carrying communications signals on multiple channels. Modified and non-modified signals with respective call durations are produced on a subset of the multiple channels. The modified and non-modified signals are then captured on the subset of channels to produce captured signals. The captured modified and non-modified signals are then analyzed to produce respective analyzed results. Then statistical information about the analyzed results as a function of the call durations is produced.

FIG. 12A shows the placement of the call duration determination unit in a network 1200 according to an exemplary embodiment. Multiple transmission links 1215 (e.g., E1 transmission links) support communications between a first network element (e.g., a mobile switching center (MSC)) 1205 and a second network element (e.g., a base station controller (BSC)) 1210. The MSC 1205 may provide services between mobile users (not shown) in a network and external networks, as understood in the art. The BSC 1210 may manage radio resources in a Global System for Mobile communications (GSM) for specified cells within a Public Land Mobile Network (PLMN).

A call duration detection system 1255 according to an embodiment of the present invention is connected to at least one transmission link 1215 via connections 1230, 1230′, 1240 and 1240′. A signal modifier unit 1220 may, for example, modify communications signals (not shown) on the transmission links 1215, such as by enhancing or impairing the communication signals. The communications signals (not shown) enter and exit the signal modifier unit 1220 via a pair of the connections 1230 and 1230′. The pair of connections 1230 and 1230′ also route the signals to a data capture unit 1235. Non-modified communications signals may also be captured by the data capture unit 1235 via connections 1240 and 1240′, for example, for use as control data. Captured data is then transferred from the data capture unit 1235 to a data analyzer 1245. The data analyzer 1245, based on a variety of configuration settings, may analyze the captured data to produce call duration information 1250. In one embodiment, the data analyzer may analyze at least 1,000 signals.

It should be understood that the connections 1230, 1230′, 1240 and 1240′ may connect to multiple transmission links 1215, and the signal modifier unit 1220 and data capture unit 1235 may discern traffic flows (not shown) on the transmission links 1215 in ways known in the art to modify and capture, respectively, communications signals in the traffic flows in a selective manner.

FIG. 12B illustrates a call duration detection system 1275 according to another exemplary embodiment. FIG. 12B shows the system 1275 with the data capture unit 1265 and data analyzer 1270 integrated as a single system 1260. This embodiment may improve processing speed, remove the need to store multiple large files onto disc storage, and conserve space by removing a communications link between the data capture unit 1265 and the data analyzer 1270.

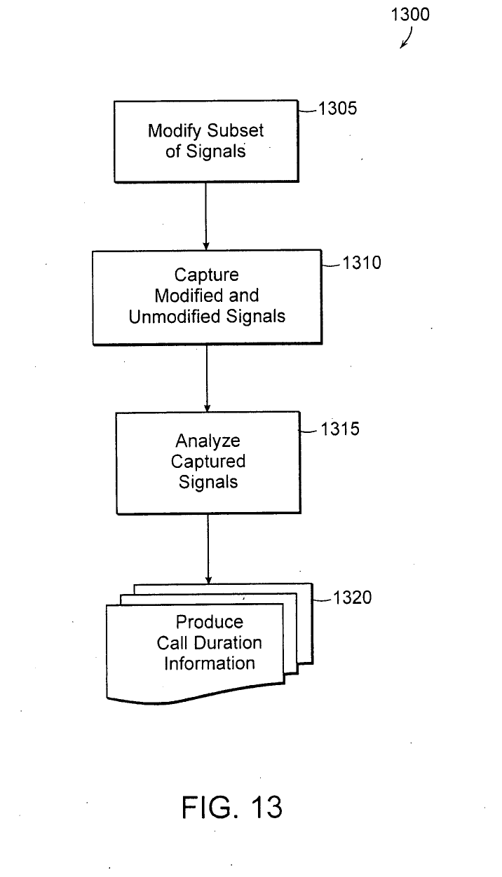

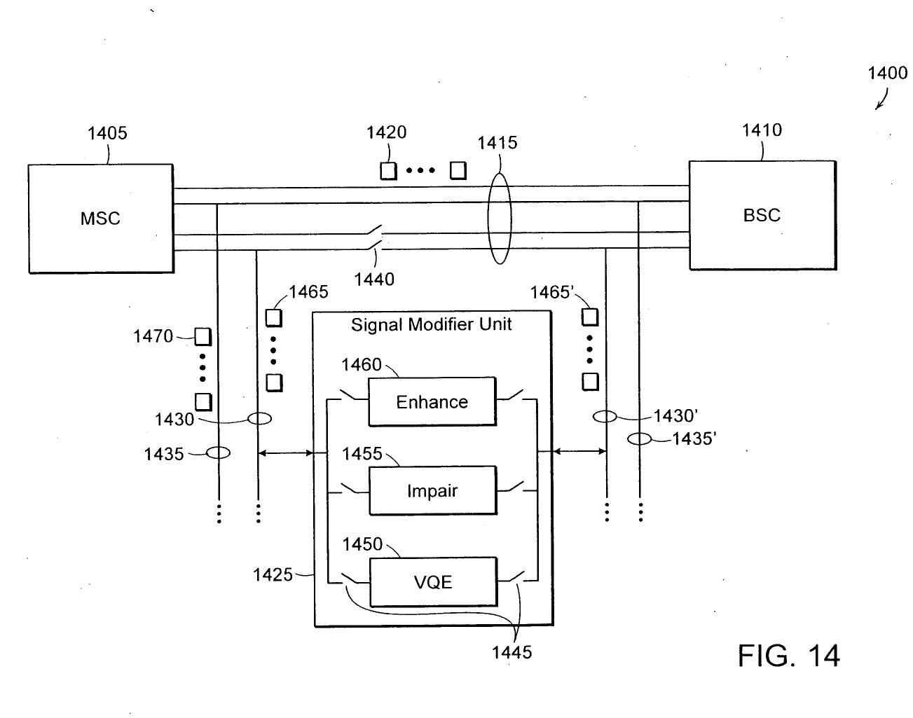

FIG. 13 illustrates, in the form of a flow diagram, an exemplary embodiment of the present invention. The embodiment of FIG. 13 analyzes modified and non-modified captured signals and produces call duration information. Call duration information is produced for both the control data set, i.e. non-modified signals, and the test data set, i.e., the modified signals. The information may be the actual call duration time or an estimate of the call duration time.

A subset of the communications signals are modified 1305. For example, for an exemplary embodiment of thirty channels on an E1 transmission link, the even number channels may be designated for the control data set, and the odd number channels may be designated for the test data set. Another example for designating channels on an E1 transmission link may be such that the first half of the channels on a transmission link (e.g., channels numbered 1-15 of the 30 channels on an E1 transmission link) can be designated for the control data and the second half of the channels (e.g., channels numbered 16-30 of the 30 channels on the same E1 transmission link) may be designated for the test data set. Both sets of data may be captured simultaneously to improve reliability and confidence level of the data.

The system then captures the modified and non-modified signals 1310 based on a variety of configuration settings that may be chosen by the user.

After the modified and non-modified signals have been captured, they may then be analyzed 1315, such as by the data analyzer 1245, 1270 of FIGS. 12A, 12B, respectively. The analysis may be completed on the system (e.g., the call duration system 1255) that captured the signals. Alternatively, the captured signals may be off-loaded to another system, and the analysis completed thereon.

The system or method then produces call duration information 1320 for the modified and/or non-modified signals. The resulting information may be the actual call duration time or an estimate of the call duration time and may be tailored based upon a variety of configuration settings used by the data analyzer.

FIG. 14 illustrates placement of a Signal Modifier Unit (“SMU”) 1425 in a network 1400, where communications signals 1420 can be modified by the SMU 1425 according to an exemplary embodiment. The SMU 1425 may be a single unit, two units, or more than two units. The SMU 1425 may be physically moved to modify signals on different locations of the network 1400, or the SMU 1425 may be connected to the network 1400 at a fixed location and have network connections switched or otherwise configured to allow the SMU to receive communications signals to modify the signals.

FIG. 14 further shows multiple transmission links 1415, including but not limited to E1 transmission links, between a first network element (e.g., a mobile switching center (MSC)) 1405 and a second network element (e.g., a base station controller (BSC)) 1410. The transmission links 1415 may carry the communications signals 1420 across a particular number of channels. For example, an E1 transmission link carries up to thirty voice channels. For the control data set, communications links may bypass the signal modifier unit 1425 via test links 1435 and 1435′. The communications signals 1420 on these channels are not modified. For example, for the control data set 1470, fifteen of the thirty channels of a particular E1 transmission link are not modified and bypass the signal modifier unit 1425 via the test links 1435 and 1435′. For the test data set, communications signals 1465 are connected to the SMU 1425 via the test links 1430 and 1430′.

The SMU 1425 is connected to the network 1400 by opening a switch 1440. The SMU 1425 may impair communications signals 1465 via an impair module 1455, enhance communications signals 1465 via an enhance module 1460, or enhance the communications signals 1465 through the use of a VQE module 1450. The selected modification unit 1450, 1455, or 1460 is engaged via a switching matrix 1445. The modified signals 1465′ are then returned to the network 1400 via the test link 1430′ for communications signals 1420 flowing left to right in FIG. 14.

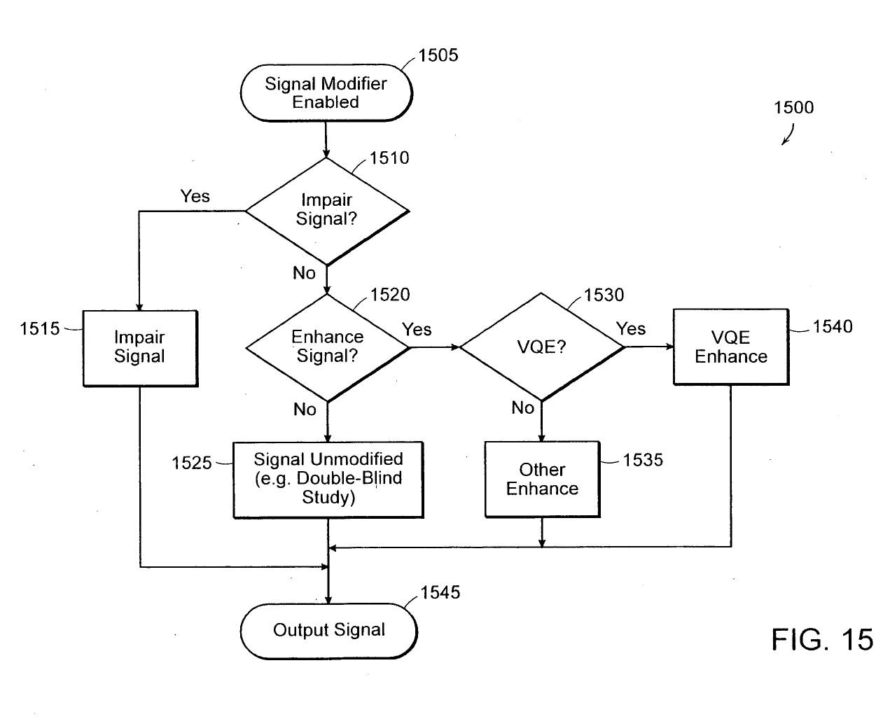

FIG. 15 illustrates, in the form of a flow diagram 1500, an exemplary embodiment of an SMU, such as the SMU 1425 of FIG. 14. The embodiment of FIG. 15 modifies communications signals that are specified to be within the control data set. In doing so, the SMU is enabled 1505. Next, the flow diagram 1500 determines if the SMU is to impair the communications signal 1510. If the communications signal is to be impaired, the communication signal is impaired 1515. If the communications signal is not to be impaired, the flow diagram 1500 determines if the signal is to be enhanced 1520. If the communication signal is to be enhanced, the flow diagram 1500 determines if a VQE is to be used 1530. If so, a VQE or the like is used to enhance the communications signal 1540. If a VQE is not to be used, other signal enhancement module(s) may be engaged 1535. If the signal is not impaired or enhanced 1520, the signal is not modified 1525. The resulting signal may then be output 1545 to a communications network.

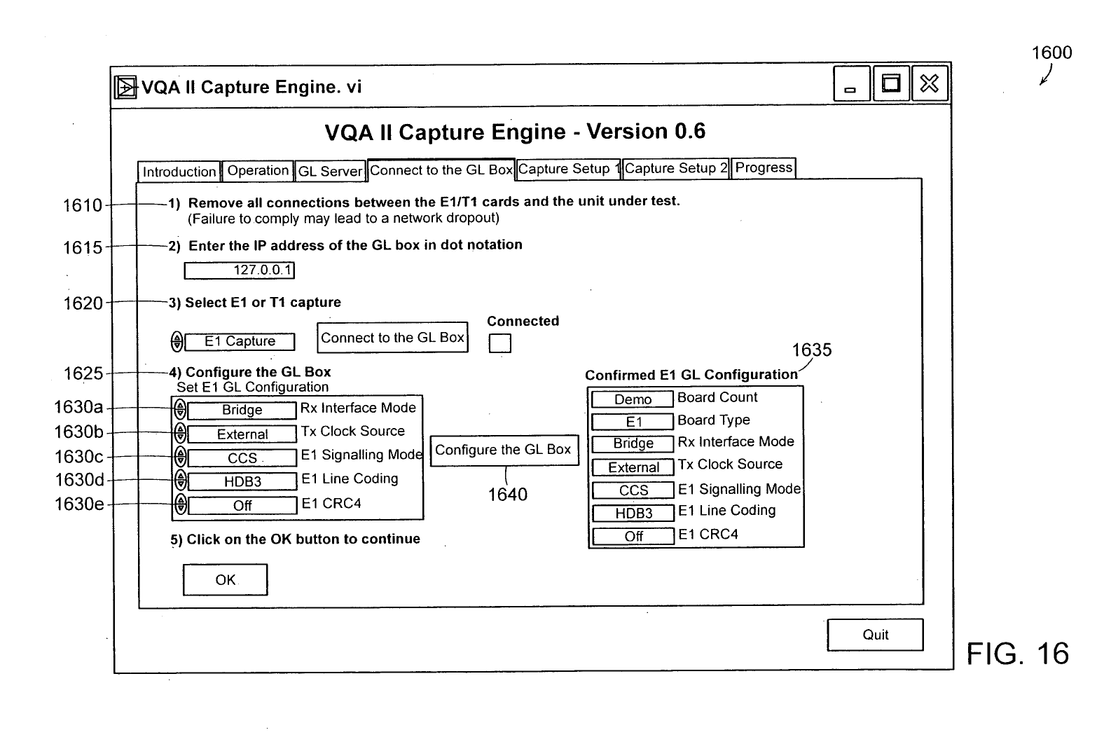

FIG. 16 depicts a screen shot 1600 of a graphical user interface for use with a Data Capture Unit (“DCU”), such as the DCUs 1235, 1265 of FIGS. 12A, 12B, respectively, according to an exemplary embodiment. The screen shot 1600 of a graphical user interface (“GUI”) shows a number of DCU connection settings that may be configured by the user. Informational or instructional text Item 1 1610 may be displayed for the user to improve ease-of-use (e.g., “Remove all connections . . . ”). In Item 2 1615, the IP address for the system may be entered in numerical IP (“dot”) notation. Item 3 1620 allows the user to select an E1 or T1 capture. In Item 4 1625, the user may set a variety of configuration settings 1630a-e for the DCU, such as Receive (“RX”) Interface Mode 1630a, Transmit (“TX”) Clock Source 1630b, E1 Signaling Mode 1630c, E1 Line Coding 1630d, and E1 CRC4 1630e. When the desired selections have been chosen, the configuration settings 1630a-e may be registered by clicking on the “Configure the GL Box” button 1640. The current configuration settings may be viewed in the “Confirmed E1 GL Configuration” field 1635. It should be understood that other forms of GUI's and non-GUI's may be presented to the user to enter configuration information.

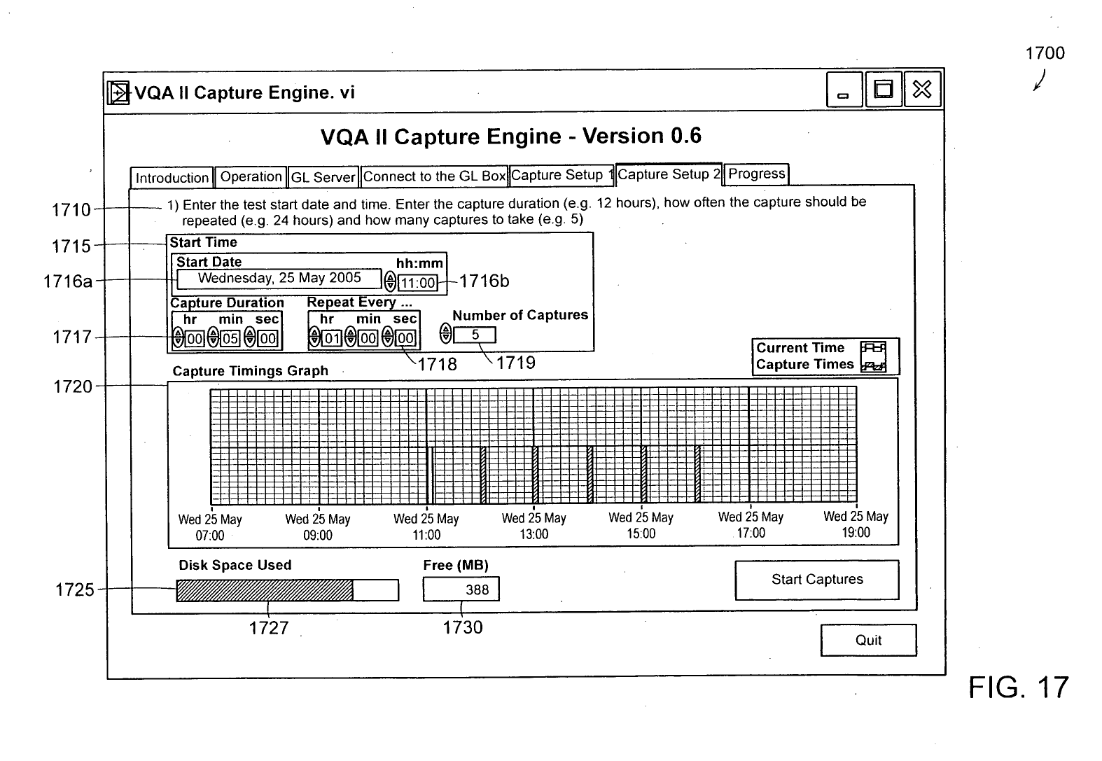

FIG. 17 depicts a screen shot 1700 of a DCU setup mode GUI, according to an exemplary embodiment. A start time window 1715 of the screen shot 1700 allows the user to view and modify the start time and capture period configuration information. Two fields 1716a and 1716b in the start time window 1715 contain the start date and time, respectively, of the capture of interest. The start time and date may be set in the future so as to allow the capture process to begin at a time when the system is unattended. A “Capture Duration” subbox 1717 displays the hours, minutes, and seconds together with toggle switches for modifying a length of each individual capture displayed in the start time window 1715. A “Repeat Every” subbox 1718 displays how often the capture is repeated (e.g., every 24 hrs.). A “Number of Captures” subbox 1719 displays the number of captures to be obtained (e.g., 5).

The “Disk Space Used” box 1725 displays, in bar-graph format, the amount of disk space expected or required for the planned capture versus amount available. The indicator 1727 may change to red if there is not enough memory available to alert the user of a state of memory expectation or requirements or otherwise alert the user, such as blinking, displaying a message, or sounding an alert. A “Free (MB)” box 1730 displays an amount of memory available in megabytes for storing captured data.

A “Capture Timings Graph” 1720 displays, in graphical form, the current time and the capture times. When the user is satisfied with the capture setup settings, the user may “click” a “Start Captures” button 1735 to continue the data capture process. It should be understood that other graph formats, such as histogram, or non-graphical formats, may also be employed to convey data capture information to the user.

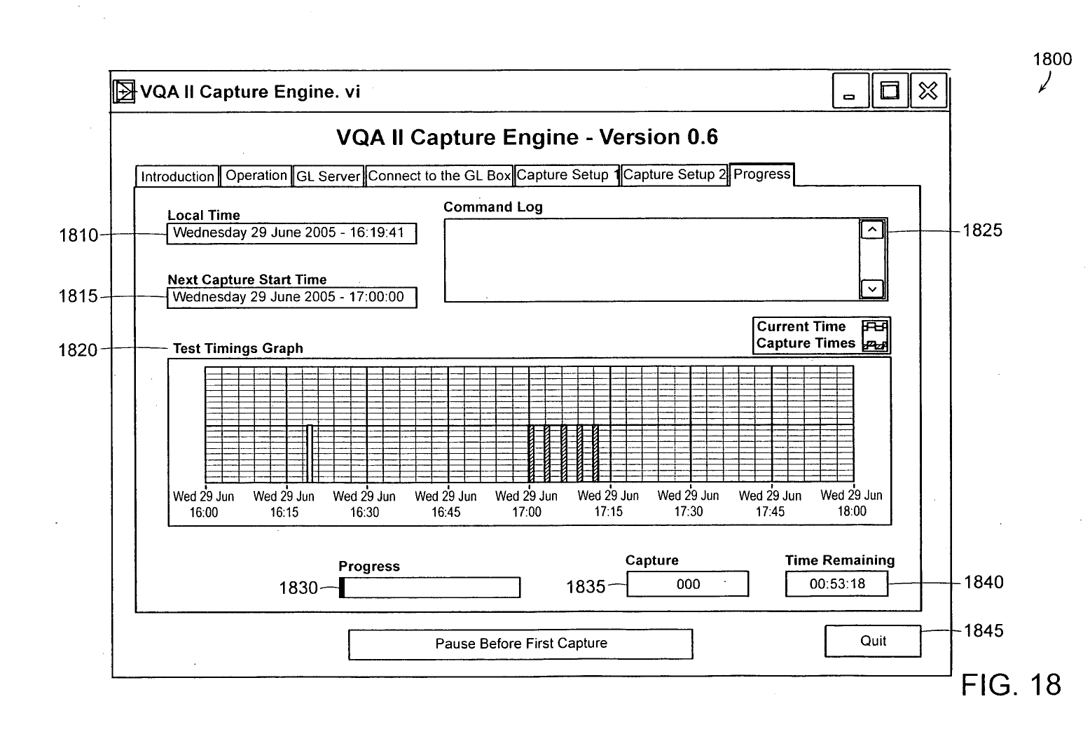

FIG. 18 depicts a screen shot of a GUI that indicates a DCU capture in progress, according to an exemplary embodiment. A “Local Time” 1810 may be displayed. A “Next Capture Start Time” 1815 may also be displayed. A “Test Timings Graph” 1820 may be used to display a current time and a capture time in a graphical format. A “Command Log” 1825 may be used to display recently executed commands of the DCU. A “Progress” box 1830 may be used to display, in bar-graph format, progress of the capture process. A “Capture” box 1835 may be used to display the capture number. A “Time Remaining” box 1840 may be used to display an amount of time remaining for the capture in hours, minutes, and seconds. The user may stop the current capture by clicking a “Quit” button 1845. Other or fewer GUI elements may also be employed to provide information of the current data capture to the user.

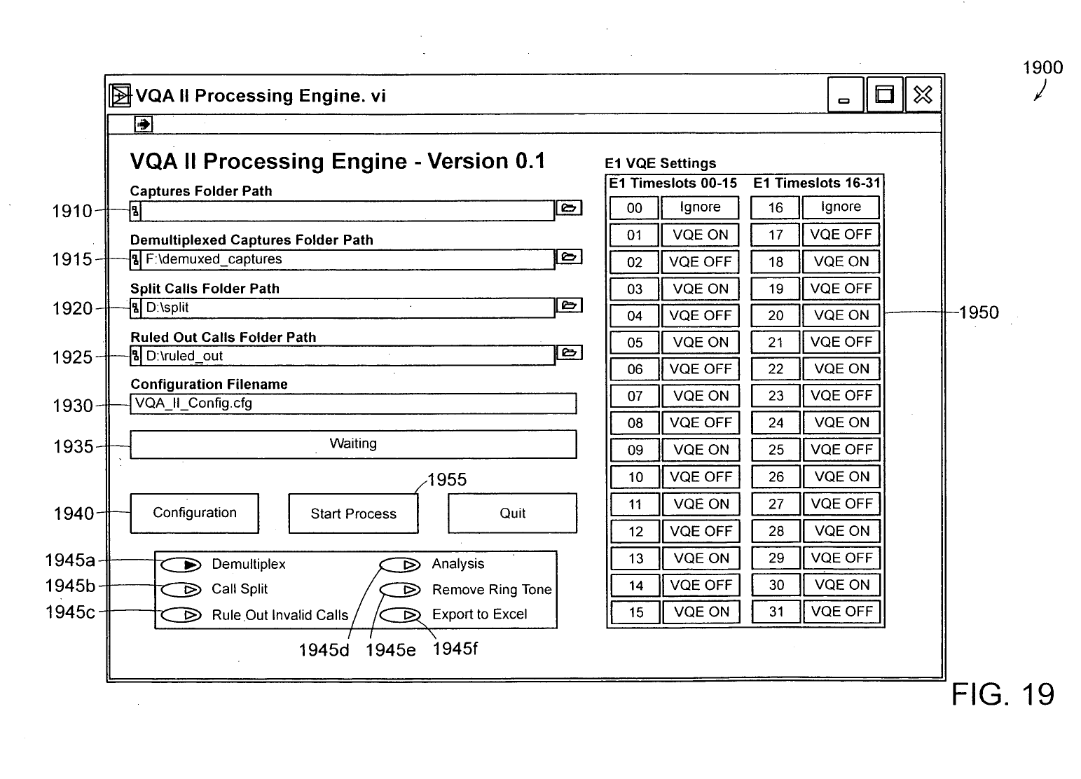

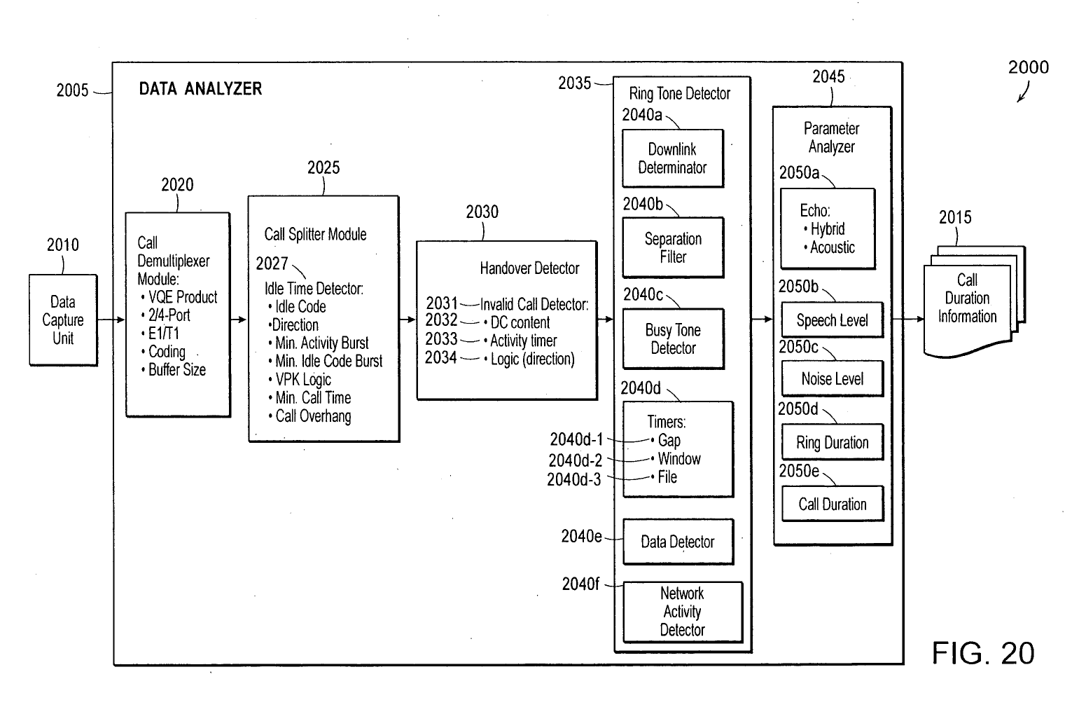

FIG. 19 depicts a screen shot of a GUI 1900 that may be provided with the data analyzer (e.g., data analyzer 1245, FIG. 12A), according to an exemplary embodiment. To provide additional flexibility, the underlying analysis process may be carried out on the same system used to capture the communications signals or on a separate system. For example, the captures may be copied onto an external disk drive for use with analysis on a different system.

If an external drive is used, the user may be provided an option of demultiplexing the captures directly on the external drive to improve processing efficiency and disk space usage. In this example, a “Captures Folder Path” 1910 is used to select a folder and filename for the initial captures. The user then selects a folder and filename for storage of the demultiplexed files by using a “Demultiplex Captures Folder Path” box 1915, where storage can be, for example, an external drive (not shown) connected via, for example, a Universal Serial Bus (USB) connection (not shown) to allow processing to take place on a separate PC. If the capture system demultiplexes files as previously described, the demultiplex button 1945a is selected, and other functions can be cleared using respective buttons 1945b-1945f.

A “Split Calls Folder Path” box 1920 allows the user to select a filename and location to store results of a split calls analysis. A “Ruled Out Calls Folder Path” box 1925 allows the user to enter a filename and location to store data filtered by the “ruled out” calls analysis feature. These files may, for example, be used for further study and optimization of the filtering process, if required. A “Configuration Filename” box 1930 allows the user to enter a configuration filename for use with a data analyzer (e.g., data analyzer 1245, FIG. 12A). A Status Bar 1935 indicates the current status of the data analysis process.

In one element, function buttons 1945a-1945f define which stages of the analysis are performed and give a degree of control to the analysis process regarding when and on which system each particular function is to be run. A “Call Split” function button 1945b enables the call extract function to identify complete calls from the channels obtained during the demultiplex function. A “Rule Out Invalid Calls” function button 1945c can be used by the user to enable and disable a “Rule Out Invalid Calls” function, which, when active, identifies network conditions that do not meet criteria defined in the rules set for valid calls. The call samples identified as invalid calls are moved into a separate file and are ignored in subsequent analysis steps. An “Analysis” function button 1945d enables a final analysis process to obtain the call parameter data. The “Remove Ring Tone” function button 1945e enables ring tone detection and removal during the final analysis process. The ring tone is not removed from the call sample, but it is ignored during the parameter analysis if the “Remove Ring Tone” function is enabled. An “Export to Excel” function button 1945f can be used by the user to export the results of the data analysis to a spreadsheet application, such as Microsoft® Excel®. An “E1 VQE Settings” function table 1950 displays E1 timeslot information for channels 0-31 for an E1 communications link. Once the user has selected a configuration via the GUI 1900, the user can “click” a “Start Process” button 1955. Additional details with regard to configuration selection is presented below in reference to FIGS. 20-22.

FIG. 20 is a block diagram illustrating a data analyzer 2005 according to an exemplary embodiment of the present invention. A data capture unit 2010 provides captured data to a call demultiplexer module 2020. The call demultiplexer module 2020 has a number of settings that allow the user to fine tune the demultiplexing process, such as VQE product, port setting, network setting, coding, and buffer size.

The call demultiplexer module 2020 has a “VQE Product” setting that allows the user to specify the VQE product, rather than the connections, simplifying configuration and reducing potential errors. With respect to the data analysis process, it is useful to have the orientation of the network connections correct to be able to identify hybrid “electrical” echo and acoustic echo in the defined ranges. Hybrid echo is generated in the Public Switched Telephone Network (PSTN), and acoustic echo is typically the only type of echo returned from the mobile direction. The call demultiplexer module 2020 may be configured to look for a complete range of echo paths in both directions, and, therefore, connection orientation is of no concern; however, the additional processing adds considerably to analysis time, and, for normal situations, there is nothing to be gained. Having already performed the capture process, setting the voice quality enhancement product for the demultiplexing process ensures that files are analyzed correctly and the spreadsheet data is presented properly.

The “2/4-Port” selection is also matched to that used for the capture process to ensure that the files are analyzed correctly and the spreadsheet data is presented properly. The 2-Port setting refers to capture and analysis without a VQE system in the circuit, whereas the 4-Port setting refers to a capture and analysis with a VQE system in the circuit.

The E1/T1 setting allows the user to specify the network architecture. The data analyzer may be used on systems such as T1 (predominantly in North America), E1 (predominantly outside North America), T3, E3, OC-31, STM-1, among other network trunk architectures. Again, this matches the settings used for the capture process and ensures the correct settings are used throughout the analysis process.

The coding setting specifies the transmission type. Typically, A-Law is used with E1 circuits, and mu-Law is used with T1 circuits; however, there can be exceptions to this rule, so a variety of selections is offered to provide for these exceptions.

“Buffer size” relates to the amount of system Random Access Memory (RAM) space made available for processing the data and the ability of the processing PC to handle large files efficiently. Buffer size is specified in seconds with a default setting of 320 seconds. This default allocates two buffers in memory sufficient to store E1 data, resulting in approximately two 82 Megabyte buffers being created, in one implementation. The buffer size function is explained in additional detail below.

A “call splitter module” 2025 processes each channel captured to identify a start and stop of each call. The call splitter module 2025 may include an idle time detector 2027. Within telecommunications networks there is usually signaling information provided to allow call tracing and billing information to be provided. Ideally, this information is used for this type of analysis to allow calls to be “split out” from the long channel captures. The problem with doing this is that most networks use a form of Common Channel Signaling, where one or more channels within the network carry the signaling information for a large number of circuits. While possible to arrange a system to analyze the call data and link it to the call captures, to do so requires knowledge of the signaling channel, identification of the circuits, and possibly release of proprietary information by the operator concerned. Example embodiments of the present invention use a novel approach that detects gaps between the calls (i.e., the period of “Idle Code”) and is thus not dependent on the signaling information.

Calls in telecommunications networks generally conform to the following sequence: a period of idle code, a period of call activity, followed by another period of idle code, etc. Therefore, an initial analysis process within the call splitter module 2025 identifies idle codes relevant to the particular network architecture being analyzed.

However, situations were identified in call samples where an idle code occurred, but the idle code was not an actual break in the call. Therefore, additional detection criteria have been developed to allow for this behavior in order to prevent false end-of-call detection from occurring.

An “idle code” setting allows for the selection of idle codes, for example, Hex 54 for E1 circuits or D5 for T1 circuits, as defined in ITU-T Q.522 section 2-12, the entire teaching of which are incorporated herein by reference. Other options exist, and a number of variations are possible.

During analysis for speech type activity, brief bursts of activity ranging from noise and incomplete handovers to short ring tones are often present. It is, therefore, a requirement in some embodiments that the call sample be greater than a specified minimum duration. This is achieved via a “Min. Activity Burst” setting. Most bursts are typically less than 0.5 seconds long; however, a chosen default of 2 seconds ensures that samples of little or no relevance to voice quality are removed since the user does not have a chance to review the quality in this amount of time.

A “Minimum Idle Code Burst” setting requires that the idle tone be continuous for a time period greater than a value defined in this setting. A default of 1 second was, and may be, chosen for this embodiment. This prevents situations where a short burst of idle code is potentially misinterpreted as a new call. These situations may occur, for example, where there is a BTS handover or in the case of PBX transfers.

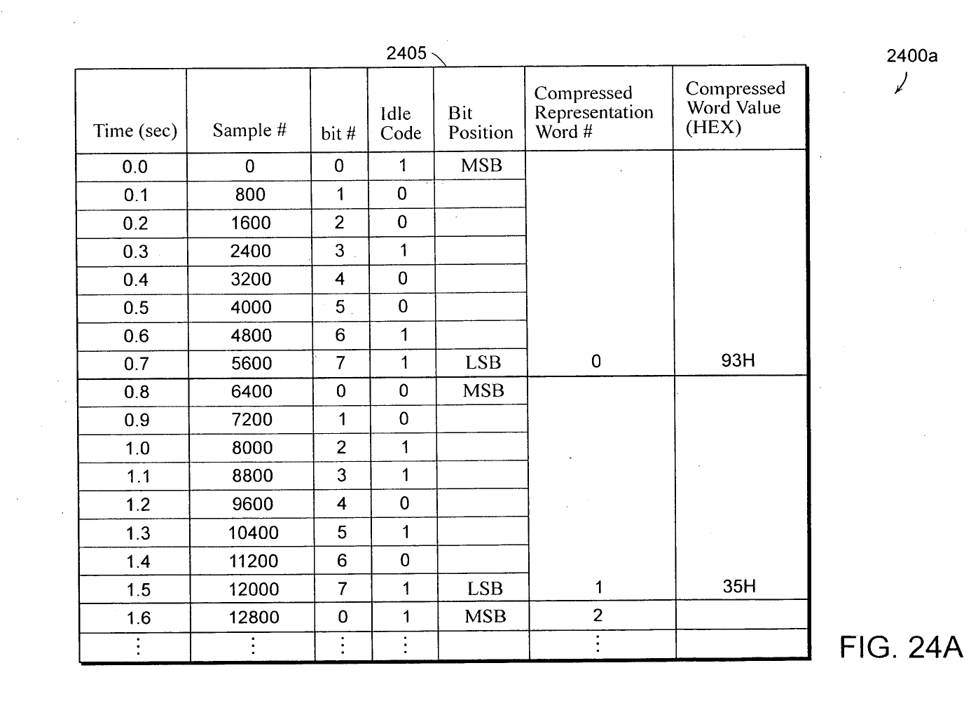

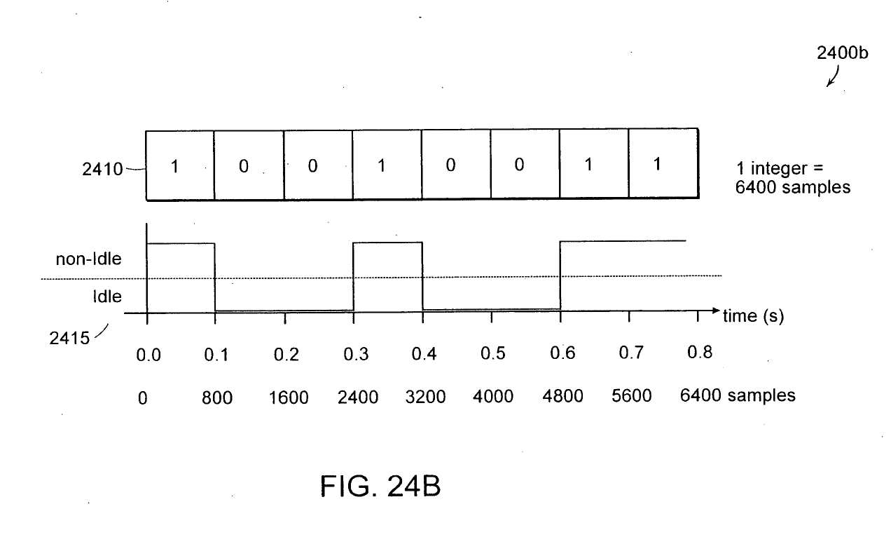

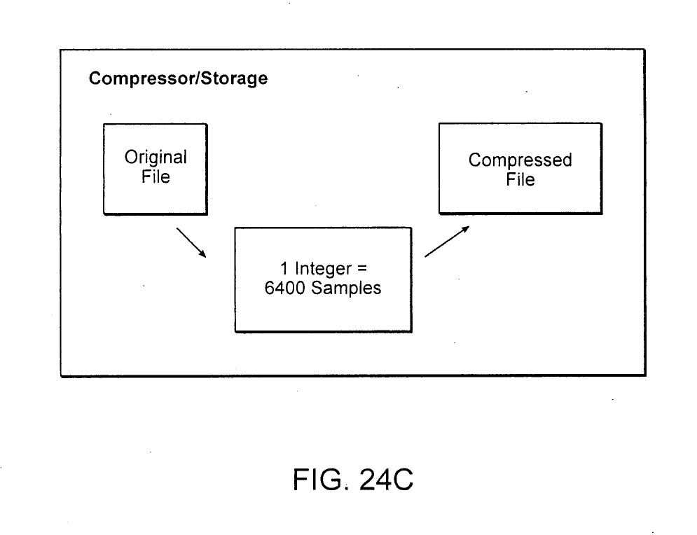

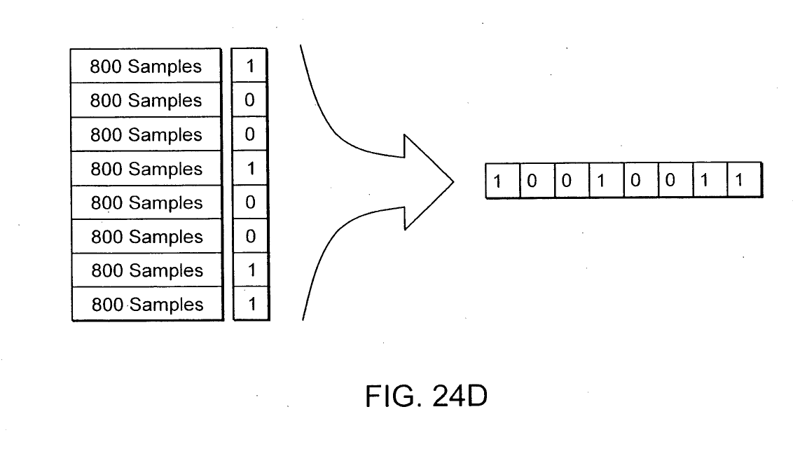

A “VPK Logic” setting is allocated with the creation of an 8-bit integer, where each bit represents 100 ms of a file indicating whether an idle code is present or not. In one implementation, the resulting file is only 1/6400 the original file size. This function is explained in further detail below and in FIG. 24. Note that “VPK” is an acronym representing a VQE Peak file and is typically used as an extension for the VPK logic file.

A “Minimum Call Time” setting allows identified samples shorter than the time defined in this setting to be filtered out from further analysis. This setting improves accuracy by allowing samples initially identified as a call but too short to be an actual call from being included in the analysis.

An “End of Call Overhang” setting ensures that there is a minimum gap of idle code in both directions in order to be able to determine that one call is finished and another is starting. This setting is a balance between the maximum period of time an idle code may be experienced during a handover and the minimum period of time when a network allows a follow-on call to occupy the same time slot. One network analysis has identified that the maximum period of idle code in the same call is typically 0.5 seconds (other than during ring tones). The typical time between calls was found to be typically 30 seconds; however, this is expected to depend on network settings and traffic density. Three seconds was chosen to be the default by experimentation.

Continuing to refer to FIG. 20, the data analysis process in the data analyzer 2005 continues with the Handover Detector 2030. As previously discussed, handovers occur when the network allocates resources in another cell in order to allow a mobile user to seamlessly move from one cell to another. If the handover does not take place (e.g., reception improves), call activity may be seen in one direction only on the channel being analyzed, even though the call may continue quite satisfactorily within another voice channel. Therefore, the handover detector 2030 prevents the analyzer from considering speech in one direction as a valid call.

In addition, a handover may take a while to complete, after which there is typically only a small amount of bidirectional activity of little value in the overall analysis. The handover detector 2030 can optimize the minimum amount of bidirectional activity accepted for final analysis as a percentage of the overall file length or in terms of duration in seconds.

The handover detector 2030 may include an invalid call detector 2031. The invalid call detector 2032 of this embodiment provides three functions to more accurately rule out invalid calls: DC content, activity timer, and logic (direction). Given that on any call sample, long or short, the data analyzer 2005 is looking for bidirectional activity greater than a defined amount of time (e.g., 2 seconds) and that a short noise burst during an incomplete handover can constitute a high proportion of a short call sample, the invalid call detector adds durational and proportional functionality to the analysis process.

The DC content filter 2032 allows the user to filter out calls where the proportion of DC activity exceeds a predetermined amount. DC activity may be an idle code or some other steady state level. For example, network analysis has revealed that a some network samples may contain a large number of calls with greater than 90% of low level DC activity, where there were only noise bursts or sometimes short data bursts. Therefore, the DC content filter 2032 may, for example, be set to accept calls with DC activity greater than 10%. The DC content filter 2032 can be set to return a “False” for calls outside this criteria.

The activity timer 2033 provides durational functionality within the invalid call detector 2031. Given the preceding criteria, on a short call of say 10 seconds duration with 1 second of bidirectional activity, the DC proportion requirement is satisfied (i.e., 90%); however, this may not be a valid call. Therefore, the activity timer 2033 provides additional criteria to filter out invalid calls further. The activity timer 2033 may require that the call contain a minimum amount of activity (i.e., non-DC activity). For example, if the activity timer 2033 is set to 2 seconds, the above example is classified as an invalid call. In other words, in some implementations, for a sample to be classified as a valid call, both functions (i.e., DC content and activity) need to be satisfied.

Lastly, the invalid call detector 2031 provides a logic 2034 setting that allows activity to be analyzed in one direction or both directions. These functions allow the user to fine tune the analysis process in order to improve the accuracy of the invalid call detector 2031. At this point, call samples have been identified and extracted. Again, samples identified as invalid calls may be ignored for analysis purposes, but may be saved in another file so that they are available for inspection should the user desire to do so.

Still referring to FIG. 20, identified call samples are then processed by a ring tone detector 2035. Call samples usually include speech activity and a ringing tone before the called party answers. Typically billing only starts when the called party answers. Therefore, to determine call duration accurately, the ringing portion may be removed. This is especially useful in calls of short duration, where the ringing tone time may be significantly more than the actual billed time. In some embodiments, ring tones are identified in situations where a call begins, then the call is transferred, and then another ring tone occurs. In this situation, the call is continuing and, therefore, is not identified as a new call, but rather a continuation of the current call.

The ring tone detector 2035 may contain a down link determinator 2040a, which uses the ring tone to determine which party initiated the call. A separation filter 2040b separates out the ring tone time, but does not delete the ring tone information. The ring tones are not discarded in some embodiments, but, rather, they are subtracted from the call sample. A busy tone detector 2040c identifies and subtracts out busy tone times, i.e., where the called party is busy with another call. As a number of calls within a network result in a busy tone, these times are preferably subtracted to accurately ascertain call duration times.

The ring tone detector 2035 may use three different timers 2040d to more accurately identify ring tones: Gap, Window, and File. Once a ring tone has been detected, it is useful to ignore activity between the ring tone (e.g., idle code, music, etc.) until the next ring tone or speech occurs. A gap timer 2040d-1 specifies an amount of time to wait before looking for the next ring tone or speech activity. If a ring tone occurs, the gap timer 2040d-1 is reset. If a ring tone or other activity does not occur, it means either the call has been terminated or the call has started.

Within a call sample, there is often a delay before a ring tone or busy tone is returned to the caller to indicate the state of the call. In some cases, this may be as much as 45 seconds or more. A window timer 2040d-2 specifies an amount of time that the ring tone detector 2035 looks for the presence of a ring tone or other activity.

Many call samples may exceed 30 minutes in duration or longer. Loading and analyzing all of these calls would take considerable processing resources and time absent some or all of the processes disclosed herein. Moreover, in some embodiments, the ring tone detector 2035 is only concerned with processing the initial ring tone which may appear and then last for an extended period of time before the called party answers, the calling party gives up, or voicemail takes the call. To improve efficiency and processing time, a file timer 2040d-3 may be used to extract only a portion of the file for analysis. Extensive network analysis has revealed that the likelihood of this time period exceeding 180 seconds was very low; therefore, the default is set to 180 seconds in some implementations.

A data detector 2040e allows the ring tone detector 2035 to detect data activity (e.g., modem) that may occur within a network. A network activity detector 2040f allows the ring tone detector 2035 to identify the beginning of network activity after a ring tone has been identified.

In this embodiment, the data is then processed using a parameter analyzer 2045. The parameter analyzer 2045 provides additional analysis flexibility by allowing a number of parameters to be fine-tuned, such as range settings for hybrid echo and acoustic echo 2050a, speech level 2050b, noise level 2050c, ring duration 2050d, and call duration 2050e.

The results of the analysis process performed by the data analyzer 2005 may then be used to create a call duration information report 2015. This information may, for example, be displayed in a spreadsheet application, tab delimited text file, or displayed on a visual display monitor.

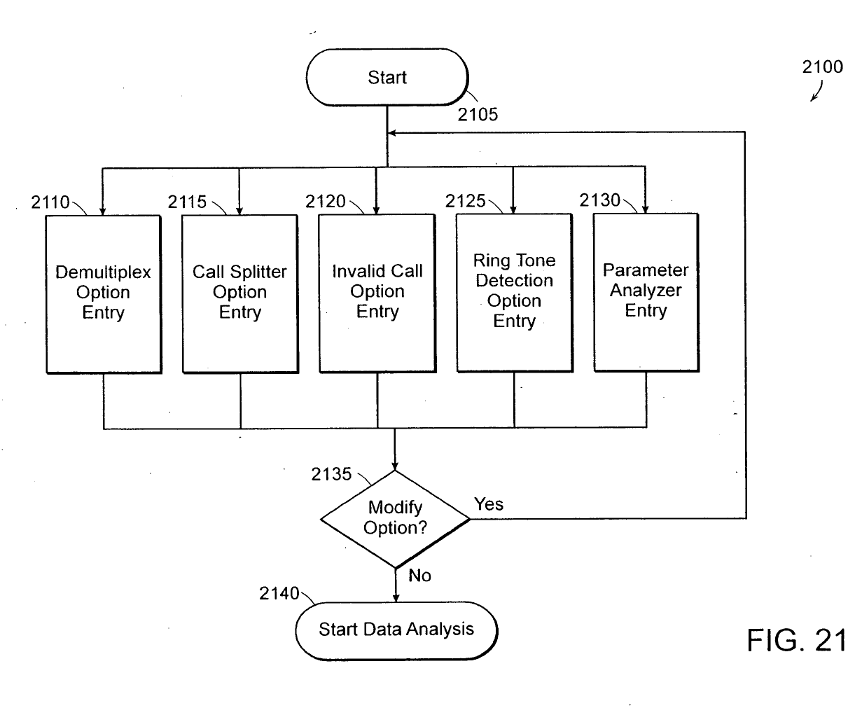

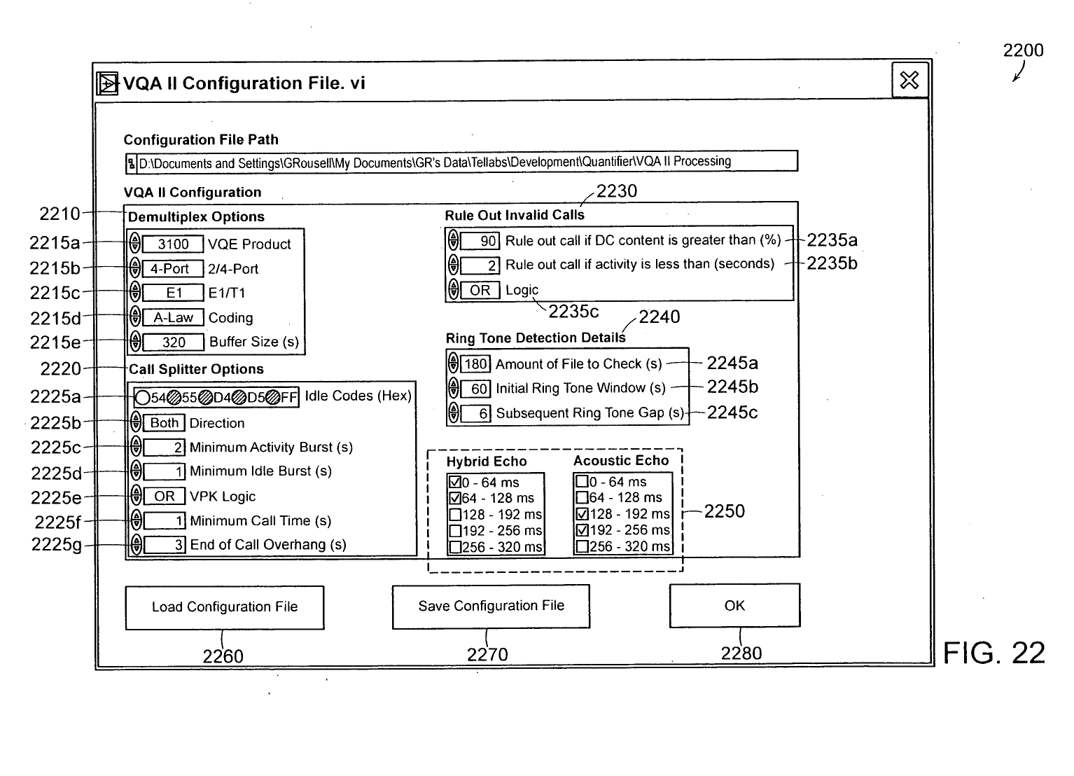

FIG. 21 illustrates, in the form of a flow diagram 2100, an exemplary embodiment of selecting options for the data analyzer 2005 of the present invention. After the communications signals have been captured and processed by the data capture unit 2010, the data analysis process begins 2105. The user then selects which option to modify, such as demultiplex options 2110, call splitter options 2115, invalid call options 2120, ring tone detection options 2125, or parameter analyzer options 2130. If additional options are to be modified 2135, the process may be repeated. Once the user is satisfied with the options selected, the data analyzer 2005 begins processing the data 2140.

FIG. 22 depicts, in the form of a screen shot 2200, a graphical user interface for an exemplary embodiment of the present invention. The screen shot 2200 shows configuration file options for the quantifier processing engine used by the data analyzer 2005.

Demultiplex options 2210, as previously described in reference to the call demultiplexer module 2020 of FIG. 20, provide a number of options to improve accuracy, ease of use, and processing efficiency. A VQE product setting 2215a allows echo path configuration to be specified by product rather than connections, simplifying configuration and avoiding potential errors. The 2/4 Port setting 2215b specifies the number of ports used. 2-Port refers to captures performed without a VQE system, and 4-Port refers to captures performed with a VQE system. The E1/T1 setting 2214c specifies the communications network architecture. Settings may include, for example, T1 (predominantly found in North America), E1 (predominantly found outside North America), T3, E3, OC-31 or STM-1. The coding setting 2115d specifies the transmission type. Typically A-Law is used with E1 circuits, and mu-Law is used with T1 circuits.

Call splitter options 2220 allow the user to customize how the start and stop of each call is identified. Among the call splitter options 2220, an idle codes (Hex) setting 2225a includes a number of Hex values for use with different network architectures. A direction setting 2225b specifies whether idle codes are looked for in one or both directions of a call. A minimum activity burst(s) setting 2225c specifies a minimum duration a call sample must be equal to or greater than in order to be a potentially valid call, and has a default setting of 2 seconds. A minimum idle burst(s) setting 2225d specifies a continuous amount of time that an idle tone must last and has a default value of 1 second. A VPK Logic setting 2225e allows the user to select logic that is applied during analysis. For example, using OR results in non-idle activity in either direction being identified as potential call activity. A minimum call time(s) setting 2225f filters out identified samples shorter than the value displayed. An end-of-call overhang(s) setting 2225g specifies an amount of time, in seconds, that must exist between calls. The default for this setting is 3 seconds.

Rule out invalid calls settings 2230 provides a number of options to customize how ruled out calls are determined. These options improve the overall accuracy of the call duration results. DC content 2235a, specified in percentage in one embodiment, defines call samples with a DC content greater than the specified percentage as an invalid call. Activity timer 2235b, specified in seconds, defines a call sample as invalid if call activity is less than the specified amount of time. The logic function 2235c specifies the logic used for the DC content and activity timer options.

Ring tone detection details settings 2240 provide a number of settings that allow a data analyzer (e.g., data analyzer 1270, FIG. 12B) to identify and analyze ring tones more accurately. These include, but are not limited to, File, Window, and Gap timers 2245a-2245c. The file timer 2245a, specified in seconds, defines an amount of the file to check for ring tones. The window timer 2245b, specified in seconds, sets an initial ring tone window size. The gap timer 2245c, specified in seconds, sets an amount of time in which to ignore any activity between ring tones.

Echo path fields 2250 contain settings for hybrid echo an acoustic echo, and are specified in milliseconds in this example. In an exemplary embodiment, five settings in increments of 64 milliseconds allow the user to specify echo ranges to be analyzed. All settings may be selected, or, alternatively, the user can select, for example, one or two ranges to reduce processing time. Other options of echo range may exist, and a number of variations are possible for other network applications.

The user may load a preexisting configuration file using a Load Configuration File button 2260. Current configuration settings may be saved in a file by clicking a Save Configuration File button 2270. Once the user is satisfied with the current settings, an OK 2280 button may be selected.

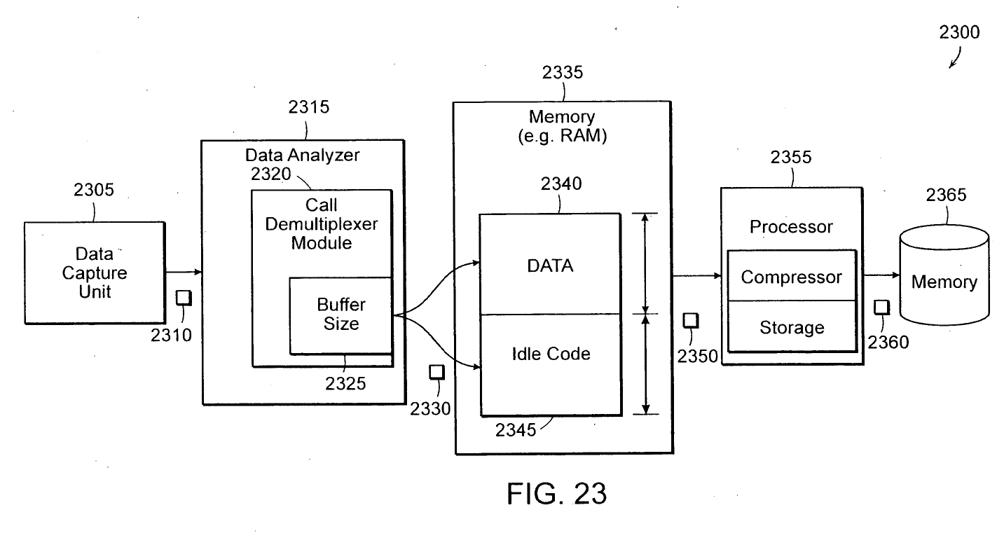

FIG. 23 illustrates an exemplary embodiment of the buffer size functionality described above in reference to FIG. 22, demultiplex option, buffer size setting 2215e. After a data capture unit 2305 processes captured signals, captured data 2310 is transmitted to a data analyzer 2315. Within the data analyzer 2315, a call demultiplexing module 2320 allocates two memory buffers in memory 2335. Based upon a buffer size setting 2325, two buffers are allocated within memory 2335: one for data 2340, and one for idle codes 2345. Choosing an appropriate buffer size allows the system to process large files efficiently by reducing the frequency of external memory storage access. For example, with a buffer size default setting of 320 seconds, the system allocates two buffers in memory sufficient to hold E1 data of this duration. This results in two 82 Megabyte buffers being reserved in system memory (e.g., RAM).

In the exemplary embodiment of FIG. 23, a processor 2355 accesses the data 2340 and idle codes 2345 stored in the memory 2335 to process it according to a configuration default or user specified as described in reference to FIGS. 19-22. When the processor 2355 finishes processing, the data 2340 may be moved to a different memory 2365, such as an external hard disk drive. Idle codes 2345 may be loaded into the data buffer 2340 to flush out any remaining data. Transferring idle codes 2345 between buffers results in a faster processing time and less frequent external memory storage access.

FIGS. 24A and 24B illustrate data represented in tabular and time sequenced formats 2400a, 2400b, respectively. These two figures illustrate an example technique that may be used to compress the sample data in memory limited embodiments.

FIG. 24A is a table 2405 that illustrates a technique for compressing captured data through use of the VPK logic function within the idle time detector 2027 described above in reference to FIG. 20. In one embodiment, the VPK logic function creates an 8-bit integer derived from analyzing samples every 100 milliseconds of a file and determines if it is an idle code (i.e., 0) or not (i.e., 1). Thus, if a sample is an idle code, the VPK logic assigns the value “0” to it; if the sample is not an idle code, the VPK logic assigns the value “1” to it. Note that reversing the value assignments or assigning other values may be done in other embodiments. Eight binary bit values are then combined to make an integer representing 0.8 seconds, or 6,400 samples of audio captures. This results in a file that is 6,400 times smaller than the original file size, as shown in the table 2405 of FIG. 24A. In this example, the first 6,400 samples of audio captures can be represented as 93H, and the second 6,400 samples can be represented as 35H.

FIG. 24B is a time graph 2415 illustrating an example of the VPK logic functionality. The data value in the first time slot between 0.0 and 0.1 seconds is a logical 1, which represents a non-idle code. Between 0.1 and 0.3 seconds, the data value is a logical 0, which represents an idle code. Between 0.3 and 0.4, seconds the data value is a logical 1 (non-idle code), between 0.4 and 0.6 seconds the data value is a logical 0 (idle code), and between 0.6 and 0.8 seconds the data value is a logical 1 (non-idle code). In this example, the 0.8 seconds is equivalent to 6,400 audio samples. The eight values in box 2410 represent the result of idle code determinations made, for example, every 100 milliseconds. Each bit represents 800 samples; thus, each eight bit integer represents 6,400 samples. Using OR logic selection means that non-idle activity in either direction is identified as potential call activity; therefore, it is likely to be data of interest for removing idle periods from the samples.

FIG. 24C is a block diagram of an example compressor/storage unit 2420 used to compress and store captured data. The compressor/storage unit 2420 includes an original file 2425 of captured data. A compressor 2430 compresses the captured data of the original file 2425 in a manner as described in reference to FIGS. 24A and 24B. The compressor 2430 stores the compressed captured data into a compressed file 2435.

FIG. 24D is a diagram that graphically illustrates the table of FIG. 24A. A series of eight hundred samples 2440 is assigned a value of logical 0 or 1 by inspecting a captured data point within the eight hundred samples and determining whether the inspected data point is an idle code. A series of eight values 2445 are combined to form a hexadecimal value (e.g., 93H) 2450. More than eight binary values (e.g., sixteen binary values) may be concatenated together in other embodiments.

While this invention has been particularly shown and described with references to example embodiments thereof, it will be understood by those skilled in the art that various changes in form and details may be made therein without departing from the scope of the invention encompassed by the appended claims.

It should be evident that various modifications and changes may be made thereto without departing from the broader spirit and scope of the present invention. For example, some of the illustrated flow diagrams may be performed in an order other than that which is described. It should be appreciated that not all of the illustrated flow diagrams or blocks within the flow diagrams are required to be performed, that additional flow diagram(s) or blocks within the illustrated flow diagrams may be added, and that some flow diagrams or blocks within the illustrated flow diagrams may be substituted with other flow diagram(s) or other blocks, respectively.

What is claimed is:

1. A system of producing statistical information about call durations, comprising:
a signal modifier unit configured to modify a subset of communications signals on a network carrying communications signals on multiple channels to produce modified and non-modified signals on at least a subset of the multiple channels;
a data capture unit configured to be coupled to at least the subset of the multiple channels and to capture the modified and non-modified signals with respective call durations on at least the subset of channels; and
a data analyzer configured to analyze captured modified and non-modified signals and produce respective analyzed results and statistical information about the analyzed results as a function of the call durations.

2. The system of claim 1 wherein the signal modifier is configured to enhance communication signals.

3. The system of claim 1 wherein the signal modifier is configured to impair communication signals.

4. The system of claim 1 wherein the signal modifier is a voice quality enhancer.

5. The system of claim 1 further including an idle time detector to determine whether idle times constitute an end of call and wherein the data analyzer is configured to determine the call durations based on a signal from the idle time detector that an end of call is detected.

6. The system of claim 1 further including a ring tone detector to determine whether ring tones constitute a new call and wherein the data analyzer is configured to determine the call durations based on a signal from the ring tone detector that a new call is detected.

7. The system of claim 6 further including a ring tone removal filter wherein the data analyzer is configured to remove ring tone times to increase accuracy of the call durations of the captured modified and non-modified signals.

8. The system of claim 6 wherein the data analyzer is configured to determine which party originated the call based on the ring tones.

9. The system of claim 1 wherein the data analyzer is configured to analyze at least 1,000 call samples.

10. The system of claim 1 further including a handover detection module and wherein the data analyzer is configured to analyze call handovers.

11. The system of claim 1 further including a handover detection module and wherein the data analyzer is configured to increase accuracy of the call durations of the captured modified and non-modified signals by discarding incomplete calls or handovers.

12. The system of claim 1 wherein the data analyzer is configured to consider call durations maintained in cases of a momentary idle code or ring tone to increase accuracy of the call durations of the captured modified and non-modified signals.

13. The system of claim 1 wherein the data analyzer is configured to determine network activity prior to speech activity to increase accuracy of the call durations of the captured modified and non-modified signals.

14. The system of claim 1 wherein the data analyzer produces information about the analyzed results with statistically significant results at a confidence level of at least 95%.

15. The system of claim 1 wherein the data capture unit and the data analyzer compose a single system.

16. The system of claim 1 wherein communications signals include at least one of the following signals: telephony, optical, or data signals.

17. The system of claim 1 further comprising:
at least two memory buffers reserved to store data processed by the data analyzer, wherein a first buffer of the at least two memory buffers is configured to store signal data and a second buffer of the at least two memory buffers is configured to store idle code data.

18. The system of claim 17 further comprising external memory storage, wherein the processor stores processed data to the external memory storage.

19. The system of claim 1 further comprising:
a VQE Peak (VPK) detector to determine if captured modified and non-modified signals contains an idle code and compress captured modified and non-modified signals containing an idle code;
a storage unit to store compressed output from the VPK detector; and
a VPK file to store the integers, the VPK file consuming at least an order of magnitude less storage space than storage space for the captured modified and non-modified signals in a non-compressed format.

20. The system of claim 19 further comprising:
a VPK logic selector to select whether the VQE Peak detector is configured to detect activity on the communications signals in one direction or both directions.

21. A method of producing statistical information about call durations, comprising:
modifying a subset of communications signals on a network carrying communications signals on multiple channels to produce modified and non-modified signals with respective call durations on at least a subset of the multiple channels;
capturing the modified and non-modified signals on at least the subset of channels to produce captured signals;
analyzing captured modified and non-modified signals to produce respective analyzed results; and
producing statistical information about the analyzed results as a function of the call durations.

22. The method of claim 21 wherein modifying the subset of communications signals includes enhancing signal quality.

23. The method of claim 21 wherein modifying the subset of communications signals includes impairing signal quality.

24. The method of claim 21 wherein modifying the subset of communications signals includes using a voice quality enhancer.

25. The method of claim 21 further including analyzing whether idle times in the captured modified and non-modified signals constitute end of calls and determining the respective call durations accordingly.

26. The method of claim 21 further including analyzing whether ring tones constitute a new call and determining the call durations accordingly.

27. The method of claim 26 wherein determining the call durations includes removing ring tone times to increase accuracy of the call durations.

28. The method of claim 26 further including using the ring tone times to determine if a mobile user initiated the call.

29. The method of claim 21 wherein analyzing the captured modified and non-modified signals includes analyzing at least 1,000 call samples.

30. The method of claim 21 wherein analyzing the captured modified and non-modified signals includes analyzing call handovers.

31. The method of claim 21 further including increasing accuracy of the call durations of the captured modified and non-modified signals by discarding incomplete calls or handovers.

32. The method of claim 21 further including increasing accuracy of the call durations of the captured modified and non-modified signals by maintaining tracking of call durations maintained in cases of momentary idle code or ring tone.

33. The method of claim 21 further including increasing accuracy of the call durations of the captured modified and non-modified signals by determining network activity prior to speech activity.

34. The method of claim 21 wherein analyzing the captured modified and non-modified signals includes producing information about the analyzed results with statistically significant results at a confidence level of at least 95%.

35. The method of claim 21 wherein the communications signals include at least one of the following signals: telephony, optical, or data signals.

36. The method of claim 21 further comprising:
storing processed data in at least two buffers, a first buffer storing signal data and a second buffer storing idle code data.

37. The method of claim 36 further comprising:
moving the processed data from memory buffers to an external memory storage.

38. The method of claim 21 further comprising:
determining if captured modified and non-modified signals contains an idle code at individual sample times at a rate lower than a sample rate of the captured modified and non-modified signals;
compressing the captured modified and non-modified signals based on the idle code; and
storing compressed representations of the captured modified and non-modified signals.

39. The method of claim 38 further comprising:
providing a VQE Peak (VPK) logic selector value for selecting whether a VPK detector detects activity on the communications signals in one direction or both directions.

40. The method of claim 21 wherein capturing the modified and non-modified signals includes substantially simultaneously capturing the modified and non-modified signals.

41. A computer program product for producing statistical information about call durations, the computer program product comprising a computer usable medium having computer readable code thereon, including program code which, when executed by a processor, causes the processor to:
modify a subset of communications signals on a network carrying communications signals on multiple channels to produce modified and non-modified signals with respective call durations on at least a subset of the multiple channels;
capture the modified and non-modified signals on at least the subset of channels to produce captured signals; and
analyze the captured modified and non-modified signals to produce respective analyzed results; and
produce statistical information about the analyzed results as a function of the call durations.
